(19) United States
(12) Patent Application Publication
(10) Pub. No.: US 2025/0097198 A1
(43) Pub. Date: Mar. 20, 2025

(54) ZERO-TRUST PACKET ROUTING

(71) Applicant: Applied Invention, LLC, Burbank, CA (US)

(72) Inventor: W. Daniel Hillis, Rindge, NH (US)

(21) Appl. No.: 18/887,977

(22) Filed: Sep. 17, 2024

Related U.S. Application Data
(60) Provisional application No. 63/583,346, filed on Sep. 18, 2023.

(51) Int. Cl. H04L 9/40

(52) U.S. Cl. CPC H04L 63/0245; H04L 63/0435; H04L 63/102; H04L 63/20

(57) ABSTRACT

Embodiments of the invention concern zero-trust packet routing. Zero-trust packet routing (ZPR) is a way of implementing policy-enforcing networks with tight integration into identity and device management systems. Unlike conventional networks, which route traffic based only on the information inside of the packets, ZPR networks forward every packet based on the authenticated identity of the users and services that communicate through those packets, and global policies that govern their communications.

### CROSS-REFERENCE TO RELATED APPLICATION(S)

This application claims priority to provisional patent application Ser. No. 63/583,346, filed Sep. 18, 2024, which application is incorporated herein in its entirety by this reference thereto.

### TECHNICAL FIELD

Various of the disclosed embodiments concern zero-trust packet routing.

### BACKGROUND

There is a mismatch between what computer networks are designed to do and what we want them to do. Computer networks are designed to allow network-connected devices to communicate. What we actually want networks to do is to allow users and services to communicate, and only when they are allowed to do so. The difference between these two functions is what makes network security such a hard problem. Most computer networks enable many types of undesired communication.

Today, we mitigate the harm caused by undesired communication by protecting the users and services at the endpoints, with mechanisms such as passwords. This kind of endpoint protection is of limited use if the devices themselves are compromised by computer viruses and other forms of malware. It also cannot prevent the network from being misused by malicious insiders or through unauthorized connections. Nor can it prevent denial-of-service attacks. Because endpoint protection cannot help with such problems, network operators also try to limit the misuse of the network by various forms of address-based partitioning. These methods use firewalls, VLANs, and address translation to limit communication between network segments. Yet firewalls and routers can only enforce policies on the packets that pass through them, and they can only make their decisions based on information inside those packets. They have no way to know about the users and services that communicate with those packets or the policies that should govern those communications.

### SUMMARY

Embodiments of the invention concern zero-trust packet routing. Zero-trust packet routing (ZPR) is a way of implementing policy-enforcing networks with tight integration into identity and device management systems. Unlike conventional networks, which route traffic based only on the information inside of the packets, ZPR networks forward every packet based on the authenticated identity of the users and services that communicate through those packets, and global policies that govern their communications.

### BRIEF DESCRIPTION OF THE DRAWINGS

FIG. 1 shows an ingress dock converting an agent packet received from an adapter into a transit packet for transmission through a ZPR network and subsequent conversion to an agent packet by an egress dock according to an embodiment of the invention;

FIG. 2 shows an example of how an enterprise might use traditional IP networks and ZPR networks concurrently to implement a secure Wide Area Network (WAN) according to an embodiment of the invention;

FIG. 3 shows how ZPR fits in the IP Stack at the level of the network interface, which may be software or hardware, according to an embodiment of the invention;

FIG. 4 illustrates a sequence of operations used to create a docking session from a ZIN, with a sustained bond to the ZPRnet according to an embodiment of the invention;

FIG. 5 shows the abstract ZPR-2020 protocol stack, showing the relationships between the various elements according to an embodiment of the invention;

FIG. 6 shows a notional ZPR network. The items on the bottom of the diagram represent the various physical networks over which ZPR builds the ZPR network. The items at the top are the abstract ZPR objects according to an embodiment of the invention;

FIG. 7 shows Notional Node Structure according to an embodiment of the invention; and

FIG. 8 is a block diagram of a computer system as may be used to implement certain features of some of the embodiments.

### DETAILED DESCRIPTION

Zero-Trust Packet Routing (ZPR, pronounced zip′-er) is a way of building secure networks that allow users and services to communicate within the bounds of policies. ZPR enforces communications policies on the delivery of standard IP packets that require the authenticated identity of the sender and receiver of the packet. Enforcing policy within the network allows a ZPR network to provide only explicitly permissioned communication. A ZPR network can do anything that can be done with firewalls, address translation, and VLANs, but it can also do much more. It can enforce polices that span across many physical networks, enterprise datacenters, portable devices, and cloud services. Because a ZPR network has more information than what is within the packets themselves, it can stop attacks that are difficult or impossible to defend against with endpoint protection and address-based partitioning. ZPR can also work in addition to these more traditional methods to provide a completely redundant layer of security.

Zero-Trust Packet Routing is based on four design principles:
I. Every packet must have an authenticated sender and receiver.
II. The network itself must enforce communications policies continuously and throughout the network, not just when packets enter and leave or when sessions are established. Every packet must be discarded unless it is explicitly allowed by a policy.
III. The users of the network, the devices that implement the network, and even the individuals who administer the network must not be trusted to always behave in any particular manner. The network must be enforced by policies correctly, even if one of these generally-relied-upon elements becomes unreliable, compromised, or malicious.

The ZPR architecture as described herein also follows a fourth principle, the unified management principle:
IV. The network is configured and managed as a unified resource, through the network itself.

The unified management is the opposite of the philosophy that guided the original design of the Internet, which was optimized more for rapid adoption than for security. It is not specific to Zero-Trust Packet Routing, but it fits very well with it. For one thing, unified management makes it easier to ensure the ZPR principles are enforced by the network. Also, a network that is managed in this way can take advantage of ZPR's policy enforcement to protect the network from misconfiguration, as well as from vulnerabilities created during the changeover from one configuration to the next. ZPR's ability to manage the network under network-enforced policies eliminates any need for secure back-channels for administrating the network.

There are also a few more general design philosophies that fit well with ZPR. One is that the network should reveal as little as possible about its internal configuration and activities, unless there is a specific policy to do otherwise. Another is that information within the network should be distributed only where it is needed. Another is that non-compliant activity or unexpected failures should be reported. Finally, contradicting another principle that sped up the adoption of IP, every component of a ZPR system should be conservative in what communication it accepts from other components.

As with most “Zero-Trust” systems, ZPR attempts to minimize dependency on other systems. ZPR also takes this a bit further by making ongoing integrity checks on any external service it trusts. For example, ZPR may trust an identity management system to authenticate users, but it also monitors it to make sure what it is doing is consistent with policy assertions. For instance, if there is a policy assertion that says a user cannot be in two different locations at the same time, or that no intern can be an administrator, the ZPR network verifies that the identity management system follows these rules. It can do so, because it has global information about communications of users and services.

ZPR operates at the Internet Layer of the network stack, which roughly corresponds to Layer 3 in the OSI 7-layer model. Because of this, everything that is built on top of IP, including TCP, UDP, and all the higher-level protocols that are built on top of them, can use ZPR.

The following discussion describes ZPR and how it can be used to build a network that is compatible with existing IP devices, services, and application software. The design described reflects some basic design choices. The network can deliver either IPv4 or IPv6 packets. It is implementable on general-purpose computers, and easy to migrate to special-purpose packet-switching hardware. Users of the ZPR system can make use of services that are not part of the ZPR system, such as a domain name service (DNS) or a trust evaluation service. Although there are security advantages to these services communicating through the ZPR network is not required. Communication to and within the network can run over point-to-point connections, multi-point connections, or over a standard IP network.

### Agents and Identity

The entities that communicate through a ZPR network are called agents. Agents may be people, devices, software services, networks, or combinations of these, such as a person using a specific device. The communications policy of a ZPR network specifies when, how, and how much the agents can communicate through the network. The policy applies to all types of agents, not just devices, because the network operates in coordination with the identity management system.

ZPR works with the identity management system to authenticate the identity of agents. The core function of a ZPR system is to enable agents to communicate, but only when allowed to do so by policies. These policies depend on the identity of the communicating agents and are enforced continuously throughout the network, not just when communications sessions are established.

Unlike many systems, which define identity by a single identifier such as a device address or a username, a ZPR system supports flexible, mufti-factor identity. The identity of an agent is a set of attribute/value pairs. Attributes of an agent may also include information that changes over time such as the location of the agent, the devices it is using to communicate, the groups to which the agent belongs, etc. For example, the AGENT-TYPE attribute of an agent might be EMPLOYEE-USING-MANAGED-LAPTOP, with other attributes specifying EMPLOYEE-ID and LAPTOP-SERIAL-NUMBER. In the case of an agent that is a server, one of the attributes may be URL, with a value that specified a URL used to access the service. ZPR works with the identity management system to verify both the unchanging identity and the changing attributes of the agents. The policies of the ZPR system determine when and how attributes of the identity of an agent are authenticated.

Each agent has at least one associated ZPR Identifier Number (ZIN), which in embodiments of the invention has the format of IPV4 or IPv6 address. Because it is in this format, the ZIN may be treated by an application as an IP address for communication with the agent through the ZPR system. The ZIN may be an attribute of the agent's identity, but in general it is not. In some cases, the agent may use a range of ZINs, for example a range defined by a prefix.

In some cases, an agent may correspond to a group of cooperating individuals. This is used, for example, to implement policies that require the cooperation of multiple individuals to enable specific types of communication, such as requiring the cooperation of multiple administrators to change network policies. An agent may also correspond to a gateway network that delivers packets in a certain address range. That network may be a conventional IP network, or it may be another instance of a ZPR network, with policies of its own.

### Compliant Flows

ZPR makes use of various kinds of secure channels to communicate information in a way that is resistant to eavesdropping and tampering. The ZPR network creates a specific type of secure channel called a compliant flow between agents. The ZPR network automatically establishes a compliant flow for any policy-compliant communication between agents. It does this by associating each packet of the flow with a permission called a visa. Every ZPR packet has an associated visa that must be valid while the packet transits the network. ZPR packets do not carry source of destination addresses. The packet's visa specifies the procedures that govern the processing of the packet that route it to the correct destination and enforce policies as it travels on the compliant flow. These procedures are applied each time the packet is forwarded, ensuring that the policy enforcement reflects changing conditions and changing policy. This contrasts with conventional network sessions, which typically enforce policy only at the time a new session is established and at the endpoints or periphery of the network. A compliant flow may have multiple visas associated with it over time, and even at the same time. Thus, the compliant flow is compliant in both senses of compliant: it conforms with policy, and it adapts to changing conditions.

All packets in a compliant flow do not necessarily travel across the same path through the network, but ZPR takes advantage of the fact that they often do. The forwarding system uses heuristics to encourage them to do so because it improves performance. For example, the forwarding process may preferentially transmit a packet on the same path that was used to transmit the previous packet of the same flow. Because ZPR packets carry information that specifies their associated flow, caching information in association with the flow can make caching more effective than it would be in a conventional packet network.

Compliant flows are typically point-to-point bidirectional flows, although the policies they enforce may be asymmetrical. ZPR also supports other types of compliant flows such as multicast flows. Compliant flows are defended against packet tampering, but they have no mechanisms for flow control or retransmission. As with other Internet-layer protocols, compliant flows carry packets on a best-efforts basis, allowing them to be discarded or duplicated.

ZPR enforces policies on compliant flows. These policies may or may not require the packet payloads to be encrypted by the network. Normally, endpoints perform their own encryption to protect the confidentiality of communication. The network may re-encrypt data to increase the difficulty of unwanted traffic analysis when this is a requirement. Depending on the use of the network, this may or may not be an important security concern.

### The ZPR Network

The core of a ZPR system is a policy-enforcing ZPR network that includes a set of nodes, a visa service, an admin service, and a communication system. Some nodes are docks that move packets in and out of the network. Others are forwarders that forward messages within the network. Docks are either gateways to other networks or internal docks that allow internal services, such as the visa service, to communicate through the ZPR network. The communications system enables nodes to communicate with other nodes.

An individual instance of a ZPR network is called a ZPRnet. The function of a ZPRnet is to allow agent packets to travel between docks. Packets have authenticated sources and destination agents and can only travel through the network when allowed to do so by the policies. Unless packets are specifically allowed, they are discarded at the source. Policies can reference the identity of the agents; the authentication of attributes of the agent's identity; the time, the location, the bandwidth, and volume of a communication; the port numbers and packet protocols used for a communication; trust evaluations provided by a trust evaluation service; and the availability of specific resources within the ZPRnet.

### Overview of how Packets Travel Through a ZPR Network

Agents communicate using packets standard IP format, called agent packets. An agent packet travels through the network from an ingress dock to an egress dock. The ingress dock receives an IP packet and converts it to an internal packet. Each dock is connected through the communication system to all other docks through links. The connection may go directly from dock to dock, or it may pass through one or more forwarders. Both docks and forwarders enforce policies on the transmission of packets.

As described in more detail below, each internal packet is associated with a visa that specifies where the packet should go and what procedures should be applied to processes it. These procedures enforce the network policies. A packet is discarded unless the policies allow it to be forwarded or delivered. If allowed, the packet is forwarded to the egress dock.

On reception of an internal packet, the egress dock verifies that it was transmitted unaltered from the ingress dock. This is enabled by a message integrity check value (MICV) in the payload. The egress dock uses keys associated with the visa to verify MICV and to decrypt the payload if necessary. A successful check demonstrates that the message passes through the network unaltered, and that the network correctly maintained the association with the visa, configuration, and payload length. Once this is verified, the egress dock converts the transit packet back to an agent packet and delivers it.

### Network Components

A ZPR network is assembled from a collection of network components which implement the function of a node, a server, or some combination of those functions. A network component may correspond to a physical device, such as a box, or it may be a virtual network component such as a virtual processor on a cloud service. Network components may be specialized devices, or general-purpose computers, with or without specialized packet switching hardware. A programmable network component always implements a component management service to manage its programming and configuration.

The ZPR architecture assumes that any single component may be comprised and that the compromise of a component compromises all the functions that are implemented on that component. For this reason, the visas and admin services are implemented by multiple servers on multiple components.

### Links

Communication between nodes takes place over links. Inter-component links are assumed to be vulnerable to eavesdropping, tampering and denial of service. ZPR uses link encryption to protect communication between components. Each link is encrypted independently, with its own keys. Depending on policies, a ZPRnet may require inter-component links to be resistant to traffic analysis. In addition to full encryption, analysis-resistant links use standard traffic-padding methods to hide traffic rates and sizes.

Links implement a communications link layer that corresponds to Layer 2 of the Internet and OSI 7-layer model. A link between components may be a point-to-point connection that may be implemented as a physical link, such as cable or fiber; or a virtual link, such as a tunnel through a substrate network. Links within a component, called internal links, are assumed to be secure. An internal link may either be a point-to-point connection or a multi-point link that connects multiple nodes. A multipoint link may be implemented as a bus, a switch or a component-internal network. On a multipoint link, the component determines the means of directing information among the linked nodes.

### A ZPR System: ZPRnet, Agents, and Adapters

A ZPR system consists of a ZPR network (the system's ZPRnet), agents, and adapters that allow the agents to communicate with the network. The purpose of a ZPR system is to allow authenticated agents to communicate with one another securely when allowed by the policies.

The admin service, the visa service, and the component management services are internal agents within the ZPRnet. The ZPR system makes use of an identity management system, which is preferably also an agent communicating through ZPRnet.

Adapters are usually implemented as operating system extensions that use standard IP interfaces. An adapter communicates with a dock of the ZPRnet through a secure channel called a docking session. Each agent communicates with the ZPRnet through an adapter that associates the agent's communications with an authenticated identity. Allowed communication packets travel from a source agent to its adapter; through a docking session to the ZPRnet; through the ZPRnet; back through a docking session to an adapter; and finally, to a destination agent.

Once the docking session is established it is used for all communication between the adapter and a dock of the ZPRnet. Control communication is transmitted using the ZPR Interface Protocol (ZIP), or some other interface supporting similar functions. An adapter is not required to use ZIP, but it needs to support the functions of ZIP. For example, it may use alternatives when the dock and adapter are implemented on the same hardware device.

The ZPRnet uses the functions of ZIP to interact with adapters to assist in determining and authenticating the identity of an agent that is communicating through the adapter. This authentication, either to obtain a visa or to connect to a dock, is associated with the agent through the docking session. By communicating through a docking session, the adapter demonstrates its association with the authentications each time it sends an agent packet over the secure channel that was used to facilitate the authentications.

An adapter can handle agent packets and authentication for more than one agent. Each agent packet that an adapter transmits to the ZPRnet usually specifies the ZIN or the agent that originated the packet as the source address in the header of the packet or, as explained later, a ZIN is dynamically allocated for this purpose. Each agent does not necessarily use a single ZIN and each ZIN is not necessarily only associated with a single agent. The adapter may handle a range of network addresses defined, for example, by an address prefix. This may be used to facilitate the use of an adapter as gateway to another network.

When multiple agents using the same ZIN are connected to the ZPRnet via the same docking session, for example multiple services running on the same host, packets addressed to different agents use different fields in the agent packet such as port numbers and protocols, to distinguish among the agents. The adapter and host can then deliver packets to the proper agent based on these fields.

Once an adapter has transmitted an agent packet to a particular destination agent, using a particular ZIN as a source address, the visa service records that the ZIN is connected through that adapter, allowing other agents to transmit packets to that agent. It is also possible for the adapter to use ZIP to inform the ZPRnet that an agent with a specific ZIN can be contacted at the adapter.

Adapters are not trusted components of the ZPR network. ZPR does not specify communication methods and protocols that can be used between an adapter and agent. For example, an adapter may use local sockets for API invocation on shared hardware, a user interface, or network-style communication using the Internet Protocol. The latter can be local within a system or over an external network, which can be the same as the substrate IP network.

A ZPR network does not rely upon adapters to enforce the policies. It also does not reveal to them information that they do not require, such as visas, network policies, internal network addresses, or even the internal packet formats.

### Docking Sessions and Tethers

Each docking session can have multiple distinguishable streams of communication. Some of these streams are used for tethers to move agent packets to and from the ZPRnet. Some docking sessions also have a second type of stream, called a ZIP stream, that allows the adapter to establish additional tethers. Tethers are internet-layer connections that transmit packets using IP protocol. The ZIP stream uses ZPR Interface Protocol (ZIP), which is a transport-layer protocol.

Each stream has a stream number. The ZIP stream uses a reserved stream number. Each tether of a docking session is assigned a stream number by the dock. A tether's stream number is used in conjunction with the node number of the dock to form a unique tether address for each tether in the ZPRnet. Each tether has exactly one tether address. A security advantage of a ZPR system is that tether addresses are not visible outside of the ZPRnet, which hides such internal information used to route packets from the adapters and agents. Tether addresses are not explicitly stored in internal packets, but are derived from their visa ID.

More than one agent can communicate over a single tether—for example, agents that are different applications running on the same machine. Depending on the connection policies, it is possible for a single agent to have more than one docking session to a ZPRnet at the same time, at the same or at different docks. This may happen for example, when a single human agent uses multiple devices simultaneously. In such a case, a single agent may have multiple tether addresses. An adapter can also communicate with more than one ZPRnet, in which case it uses separate docks and docking sessions for each.

An ingress dock attempts to associate each agent packet it processes with a visa that matches the agent packet using a classification rule. Classification rules check if the header of the agent packet matches the required field values of the visa. An ingress dock first attempts to use the most recent visa used on the same tether. If that visa does not match, it attempts to find a matching visa already held in the node. If it does not have one, it requests a visa from the visa service. The request for a visa specifies the source header information of the incoming agent packet and the tether address of the tether on which the agent packet was received in the request. If the dock locates an applicable visa for the received agent packet it converts that agent packet to an internal packet, as specified by the visa. It associates the internal packet with the visa and uses the information in the visa to process it. This processing procedure enforces the appropriate policies and causes the internal packet to be forwarded or discarded.

A ZPR network only requires adapters to use different tethers for transmitting packets when the packets come from different networks with conflicting address spaces. However, docks need to find applicable visas for incoming agent packets. They can do this most efficiently when the packets from the same compliant flow travel through the dock on the same tether and packets from different flows travel on different tethers. For this reason, an adapter should preferentially create and use different tethers for different compliant flows. For example, adapters preferentially associate specific compliant flows from one agent with a specific tether to help improve the efficiency or performance of the dock. Because the adapter may not actually know the policies of the ZPRnet, adapters may still sometimes send packets from different compliant flows through the same tether, but because the adapter has information that the dock does not, separation of different compliant flows onto different tethers provides opportunities for efficiency that would otherwise be lost.

### Network-Enforced Policies

The policies enforced by a ZPR network are set by admins, who are agents that have access to a special set of tools, services, and credentials that allow them to administer the ZPR network through the network itself. The admins describe policies in a policy specification that is expressed in some formal policy description language and communicates a compiled version of this to the network using ZPR Administrative Protocol (ZAP). The policy specification defines multiple categories of policy that govern the activity of a ZPR system, including communication policies, authentication policies, connection policies, and reporting policies.

Policies can depend on a trust evaluation service that evaluates trust in agents and other system components. Such services allow information to be combined from a variety of sources, inside and outside the network to assign a current trust score for the agent or component. For example, an agent that has repeatedly attempted and failed to authenticate when trying to connect to many different services from an unrecognized network address, may be deemed less trustworthy than an agent that has always authenticated correctly from a familiar network address.

ZPR can enforce any policies that that can be enforced with local mechanisms such as proxies and fire walls, but because the ZPR network has global information, it can also enforce global policies. For example, it can enforce global limits on rules resource usage, e.g. bandwidth allocation, and connectivity, such as limiting the number of places an agent can connect to the network simultaneously.

The ZPR policy language (ZPL) is described elsewhere. Besides the allowances described below, it also offers a way to make assertions that provide clarity about what is and is not allowed. The combination of the policy and tests helps ensure that unwanted behaviors are not created, and the trusted sources are trustworthy. Assertions can check for conditions such as “interns should never be allowed access to customer database servers” or “no member of the marketing group should be able to move more than 10 Gigabytes out of the company in a single day.” Assertions are not really policies, but rather checks on policies and other systems. They are supported in the policy description language.

### Communication Policies

Communication policies describe which agents are allowed to communicate through the ZPRnet, the circumstances under which they are allowed to communicate, and which resources should be allocated for their communication. The circumstances can include which docking session node or type of docking session the agent is using, what ports and packet formats are being used, the identity attributes and authentication status of the agent, the time, and information provided by a trust evaluation service. For example, a restrictive policy could allow an authenticated agent to send packets with a specific port number to another authenticated agent at limited bandwidth only if it is connected to the network at a specific dock during a specific time period. Although it is not the best way to take advantage of ZPR, a very permissive communication policy could allow every agent to send any packets, claiming to be from any source, without any form of authentication, at any available bandwidth, at any time, from any location to any other ZIN. This permissive policy would result in a ZPRnet that functions much like the public Internet.

Communication policies traditionally differentiate quality of service (QOS) by dividing traffic into classes with different priority levels. ZPR can support this, but it also provides more general mechanisms for resource allocation. For example, a policy may specify limits on how much total information can be sent over a long time period, not just the rate at which it can be sent.

A visa can also specify which storage and bandwidth resource can be used for the delivery of the packet. This can be used to guarantee that the network allocates sufficient resources to handle important flows, without wasting that capacity when it is unused.

ZPR keeps traffic counts of the traffic that flows under each visa, which it stores in traffic counters that are allocated along with the forwarding tables and at the egress dock. Visas are associated with resource pools which define which storage and bandwidth resources are used for their transport throughout the network. These resources may be communication or storage capacity. The visa service keeps track globally of what resources have been permissioned and what resources were actually used. Multiple visas can draw from a single resource pool, and visas can be associated with more than one resource pool. Coupled with the centralized coordination of visa issuance, resource pools can provide flexible allocation of network resources for different traffic classes because the visa can specify that collections of state be globally combined. For example, it is possible to give an agent not just a minimum guaranteed bandwidth on a flow, but a guaranteed opportunity to transmit a specific number of bits through the network over a specified period, such as an hour, or a day. Resource pools provide a way to keep bandwidth available for a burst of data scheduled within a given time period without tying up the resources for the entire period. This allows for more efficient allocation of resources.

Communication policies also specify how and when the visa service determines and authenticates the attributes of agents, as well as a maximum time that authentications are considered valid. Authentication can be accomplished by the identity management system, or through the challenge-and-response procedure requiring the agent to demonstrate that it has access to specific sets of required credentials to formulate a valid response. For example, a credential can be a password, a private cryptographic key, a token from an authentication service or device, a specific piece of biometric information such as a fingerprint, or a certificate issued by a trusted entity. A successful response demonstrates to the challenger that the agent has access to the credentials.

The visa service authenticates agent attributes and their association with each other through the docking session. An adapter helps to verify this association by proving its access to the secure channel through the docking session and to the credentials of the agent. The adapter proves its access to the docking session by transmitting the agent packets through it and proves its access to the interaction that authenticates the attributes. The authentication of attributes may take place between the challenger and the agent or its adapter, or it can rely on trusted external authentication services from an identity management system. In either case, the authentication is associated with the docking session by communicating information through the docking session, or by authenticating the association of the attribute with attributes that have been verified as associating with the docking session. The communications policies specify exactly how this must be accomplished.

The agent communication policies can specify that an authentication expires after a certain time. A visa that depends on an authentication always expires when, or before, any of the authentications on which it depends expire. Agent communication policies can also specify that the visa service should attempt to reauthenticate an agent when an existing authentication is about to expire. Authentication can also expire in certain specific circumstances, such as when the credentials that were used to authenticate cease to be honored.

The cessation of honoring a specific credential can be specified through ZAP. Such a cessation is not treated as a change in policy and can be accommodated without changing the configuration.

Authentications that do not involve the visa service, such as those used in establishing docking sessions between adapters and docks, are not a part of the agent communication policies. They are handled by the connection policies, described below.

### Connection Policies

Connection policies include linking policies and docking policies. Linking policies specify what links should be established between network components before a configuration is activated or tested and how they are established.

The connection policies specify the topology of links between network components. This topology allows every node to communicate, either directly or indirectly, with any other. If a substrate communication system only allows some pairs of components to communicate directly, for example because of network firewalls, the connection policies will only specify links between those nodes.

Connection policies also specify methods for distributing link keys to nodes connected by inter-component links. They also specify any methods required to make these links resistant to traffic analysis.

Connection policies also specify node numbers for each node in the configuration. Node numbers are unique and identify the nodes that are used on docks to generate a tether address. Unlike typical networks, ZPR can globally optimize the assignment of node numbers without the constraints of backward compatibility. Because the node numbers are used to generate tether addresses, they may be chosen to simplify the forwarding tables for the specific topology of the network and/or to support useful patterns of multicast addressing.

The connection policies also include docking policies. These specify what protocols the docks use to establish docking sessions and under what conditions they are allowed, as well as how the dock and adaptor are authenticated. Docking policies can specify limits on which adapters are allowed to establish docking sessions at which docks of the ZPRnet. In determining these restrictions, the connection policies can depend on the protocol, the time, the location, or the assessments of a trust evaluation service.

### Reporting Policies

Reporting policies specify what information is reported by a ZPRnet. Such reports may be used to monitor or adjust the behavior of the ZPR system. Reports can be sent to the admin service, the visa service, a component management service, or other services. These services can take actions in response to the reports. Reporting of information can include direct reporting or logging of information for future analysis. For example, attempts to send packets that are not in compliance with policy can be reported to a trust evaluation service as well as logged. Reporting policies ensure that reporting only takes place when the resources to do it are available. For example, reporting policies specify rules for the management of storage space available for logged information. Once storage space for logs becomes scarce, this scarcity condition is reported, and logging is adjusted to match the available resources. ZAP provides a means to read logs and to explicitly delete logged information. All reporting policies have limits to the resources they demand, in part to protect the network from attack by flooding.

### Policy Enforcement Procedures (PEPs)

Policy Enforcement Procedures (PEPs) are a simple way to manage enforcement across multiple configurations. The following discussion describes how ZPR policy enforcement can be implemented by PEPs.

### PEPs for Connection, Reporting and Communications

Policy descriptions are compiled into procedures called Policy Enforcement Procedures (PEPs) that are executed by the nodes. There are PEPs that implement the enforcement of connection, reporting and communications policies. They are loaded into nodes when they are required by the configuration. One of the advantages of using PEPs is that visas from different configurations can use different PEPs when needed and share them when possible.

Execution of a specific type of PEP requires access only to specific types of information, and the executing node may grant the PEP access only to the specific type of information it requires.

These limitations and restrictions can be enforced either when the PEPs are compiled or at the time they are executed by the nodes. The enforcement may be implemented in software, hardware, or some combination of the two.

Each PEP is associated with a unique PEP ID that can be used to specify the PEP. PEPs and their associated IDs are distributed to network components by the admin service. PEPs can be communicated through ZAP in a way that is independent of what types of network components are supported. In this case, the component management service and/or admin service can either compile and load the PEP into the various network components into a format they can execute or send them in a common format which the network components can interpret or compile. The system must ensure that PEPs only use available storage, and that their behavior degrades gracefully when free storage is scarce.

There are three types of PEPs:

Connection PEPs are compiled from connection policies, and are executed whenever docking sessions, links, and reliable, secure channels to services are established, or disestablished. When a docking session is established, the connection PEPs interact with the visa service to request permission to establish the docking session and obtain any required authentications from the adapter for establishing the docking session. The connection PEPs execute the protocols required to establish docking sessions between the adapter and dock. The connection PEPs also establish links and manage cryptographic key distribution to the linked nodes.

Connection PEPs also establish secure channels that communicate between each component and admin service, and the visa service. These services and the management services of the components are internal agents within a ZPR network. Connection PEPs use pre-issued visas to establish secure channels to them, through the ZPRnet, to internal services that communicate with an internal dock. Each network component's management service establishes reliable, secure channels to the admin service and visa service. The component management service uses these channels in conjunction with communication internal to the network component to establish reliable secure channels between nodes and the visa and admin services.

Reporting PEPs are compiled from reporting policies and are executed whenever conditions arise that can require reporting. For instance, the PEP reporting the receipt of an invalid packet is passed the bad packet when it is invoked. The reporting procedure can use this information to construct and send messages to specific reporting-related services within the ZPR system, or to record new log entries within the network component's local logs.

Communication PEPs are compiled from communication policies. They can be optimized to take advantage of special packet processing hardware available on the network component that implements the node. A visa can specify the communication PEPs that are used to process packets traveling under that visa.

One type of communication PEP, called a Dock PEP governs the conversion of incoming and outgoing packets at docks. For example, dock PEPs determine how docks represent agent packets within internal packets when they enter the ZPRnet and reconstruct them when they exit the ZPRnet. There are different dock PEPs for ingress and egress docks.

A second type of communication PEP, called a Forwarder PEP is invoked by a forwarder to transmit or discard a packet as it is transported through the ZPRnet. Forwarder PEPs have access to the packet's visa and the header of the packet, including all forwarder state conditions that are relevant for processing the packet and holding visas, including forwarding tables.

### How Resource Use is Limited by Allowances

ZPR implements limits on the amount of information that can be sent by an agent by doling out allowances when issuing new visas. These allowances are based on the allowances that are outstanding visas as well as the quantity of information that was actually sent under expired visas on the same compliant flow. Based on this information, combined with the bandwidth limits and expiration time of the visa, the visa service can limit the total amount of information that can be communicated.

The PEP parameters typically specify some number of allowances, typically two. Allowances permit a certain volume of information to be sent using a specified resource pool. The allowances on the PEP parameters are ordered in the sequence that they are to be used, so that a later allowance is used only if an earlier allowance is not available. Storage required for tracking a visa's allowances is allocated in every node that holds that visa.

One way to implement QOS policies is for communication PEPs to pass packets through a processing buffer that prioritizes packets according to the QOS under which they are sent. When a node attempts to add a packet to a packet processing buffer, it first checks if processing the packet would exceed any volume or rate limits specified in the PEP parameters for the first QOS; if the packet could not be sent at that QOS, it checks the next, and so on. If the packet could not be processed without exceeding these limits, the packet is discarded; otherwise, it is enqueued in the processing buffer, ahead of all the packets enqueued at a lower QOS.

Preferably, the rate limits that are used by the forwarder PEPs are slightly less limiting than the rate limits of ingress dock PEPs associated with the same visas such that, unless a part of the ZPRnet becomes compromised, rates are limited by the ingress dock even if there is some imprecision in the measurement of rate.

### How Connection and Communications PEPs Process Packets

Connection PEPs decrypt packets from links and docking sessions and move them into a packet processing buffer. A node processes packets that have been added to a packet processing buffer by applying a communication PEP associated with the packet's visa. If a packet is not available, it waits for a packet to be added to the packet processing buffer. A node processes a packet from the processing buffer by applying a communication PEP to the packet, which either discards or forwards the packet.

Before sending a packet across a link, the node first checks if the packet's visa has been accepted on the link. If it has not, the node heralds the visa on the link. Once there is a visa accepted on the link, the communication PEP updates any applicable volume and rate measures associated with the packet's visa and then moves the packet to link buffer. The connection PEP moves the packet from the link buffer to the link. Before transmitting a packet, the connection PEP encrypts the packet as required.

### Dock-to-Dock Encryption and the Message Authentication Code

Because endpoints normally perform end-to-end encryption, dock-to-dock payload encryption is usually unnecessary, although the dock PEPs can support it using the visa keys, if policy requires.

Dock PEPS also specify how to calculate the message authentication code. MICVs are calculated using the visa keys. MICV keys only need to remain secure until the visa expires. If the keys are discovered retroactively, nothing is compromised. In many situations, this means that it is safe to use a fast algorithm to compute the MICV, for example VMAC, even if it is susceptible to cryptographic attacks that take longer than the maximum lifetime of a visa. The length of the MICV and the algorithm used to compute it can vary from configuration to configuration and is chosen to reflect the security requirements of the network and the current state of the art in cryptographic attacks.

### Configurations

A ZPRnet can store multiple concurrent configurations. Each configuration is associated with a unique configuration ID and a configuration status. Configurations can be changed while the network continues to operate. Packets continue to be transported through the network under the policies of the configuration under which they entered the network At least two configurations can be stored in a ZPRnet concurrently.

It is possible to switch configuration with just two configurations but may be convenient to store more configurations if there is memory space available. When switching configurations, the configuration status of a configuration typically progresses from UNDEFINED, to DEFINED, optionally to TESTING, and finally to ACTIVE. Only a single configuration, referred to as the active configuration, has an ACTIVE configuration status at any given time. When a new configuration's status becomes ACTIVE the previously active configuration's status becomes DEACTIVATING and eventually reverts to DEFINED.

The uniform management principle enables node numbers to be assigned advantageously for the configuration of linked network components in the configuration. Because node numbers, links and forwarding tables are all associated with a configuration, the node numbers may be assigned to take advantage of the network topology to generate efficient forwarding tables. They may also encode information about the hardware type of the network component supported by the component management service using a dock, to facilitate the multicast flows to specific classes of component management services.

### Implementation of Configurations

A configuration consists of a set of configuration-required resources associated with each network component of the ZPRnet, and a node number associated with each node. The configuration-required resources include required nodes, links and any specific software, data, or storage that is required by the network components or nodes to allow the use of the configuration. The storage includes storage for forwarding tables, visa information, keys, traffic meters, etc. Each configuration can also have its own visa service and a visa format and the visa-service protocol.

The configuration-required resources that need to be allocated in each component of the network, include PEPs, links and storage required for holding visas and processing packets under the configuration. The component management service allocates any required resources required for a configuration before it is DEFINED. It deallocates as resources any deleted configurations that are not being used by another DEFINED, ACTIVE, TESTING, or DEACTIVATING configuration.

When the status of a configuration is switched to DEACTIVATING, deactivation takes place in two phases. The first phase is to wait until all packets that are associated with visas associated with the configuration ID of the deactivating configuration are delivered or discarded. The second phase is to either convert or cease to hold all visas associated with the deactivating configuration, and to disestablish any links that are not being used by some other configuration with ACTIVE, TESTING or DEACTIVATING status. Once these two phases are complete, the configuration status is automatically changed to DEFINED.

Nodes cease to hold the visas associated with the deactivating configuration.

The configuration-required resources can include required parameters of the configuration that are available to all nodes. The required parameters may include a maximum transmission unit (MTU), which is the MTU of the link with the smallest MTU in the configuration, and also a revealed MTU. Because the MTU is one of the few things that the network needs to reveal about itself, it reveals a single MTU for the entire network. The revealed MTU may not reflect the actual MTU of the network. The dock may fragment large IP packets into internal packets that are not larger than the actual MTU of network. Note that a ZPR packet may actually be smaller than the IP packet it carries in a compressed form in its payload.

The configuration parameters may also include a maximum allowed path length, which is the maximum number of links a packet is allowed to traverse as it travels from the ingress dock to the egress dock. The configuration parameters also specify admin service addresses and visa service addresses, which are preferably allocated unpredictably from the address space reserved for internal-use addresses for each configuration.

### Packet Formats and Visa Parameters

As mentioned above, ZPR networks process two broad types of packets, i.e. agent packets that are IP packets that enter the network through a dock, and internal packets that move between nodes across links. Agent packets are standard IP packets, in IPV4 or IPv6 format. The following discussion describes the format of internal packets as they are sent over links between network components. ZPR does not specify the formats of packets within a component.

There are three types of internal packets, called transit packets, herald packets, and herald-response packets. All internal packets specify their packet type and configuration in the header.

Transit packets carry information transiting the network between agents. They have variable-length payloads that carry a compressed representation of an agent packet and a message authentication code. A transit packet specifies a visa identifier and payload length in the header. The visa identifier is a link-specific value that specifies the associated visa. It may change as the packet is forwarded from one link to another, even though the associated visa does not.

The representation of an agent packet in the payload of a transit packet is sufficient to reconstruct the agent packet in combination with information from the associated visa. More specifically, the fields of the agent packet that have required field values in the packet's visa are not included in the payload and are instead reconstructed at the egress data using information from the packet's associated visa. For example, the source and destination addresses of the agent packet are required field values, so they are not included in the payload. Other fields such as protocols, version numbers, and ports may be required field values that can be reconstructed. The compress representation also does not need to include fields, such as an IPV6 hop count field or IPv4 time-to-live (TTL) field, that can be constructed at the egress dock.

As described below, herald packets are used to manage the use of a visa identifier on the link. They can be also used to distribute visa information in the payload.

A herald packet has a herald type, visa identifier and visa serial number in the header. The herald type indicated with the packet is a distribution, a retraction or an acknowledgement of a de-acceptance. The format of the payload, if any, is determined by the configuration.

A herald-response packet has response type, and visa serial number in the header. The herald type indicated with the packet is an acceptance, refusal, or de-acceptance. The format of the payload, if any, is determined by the configuration.

These are used for the assignment of a visa identifier and distribution of visa information. The function of these two other types of internal packets is described below.

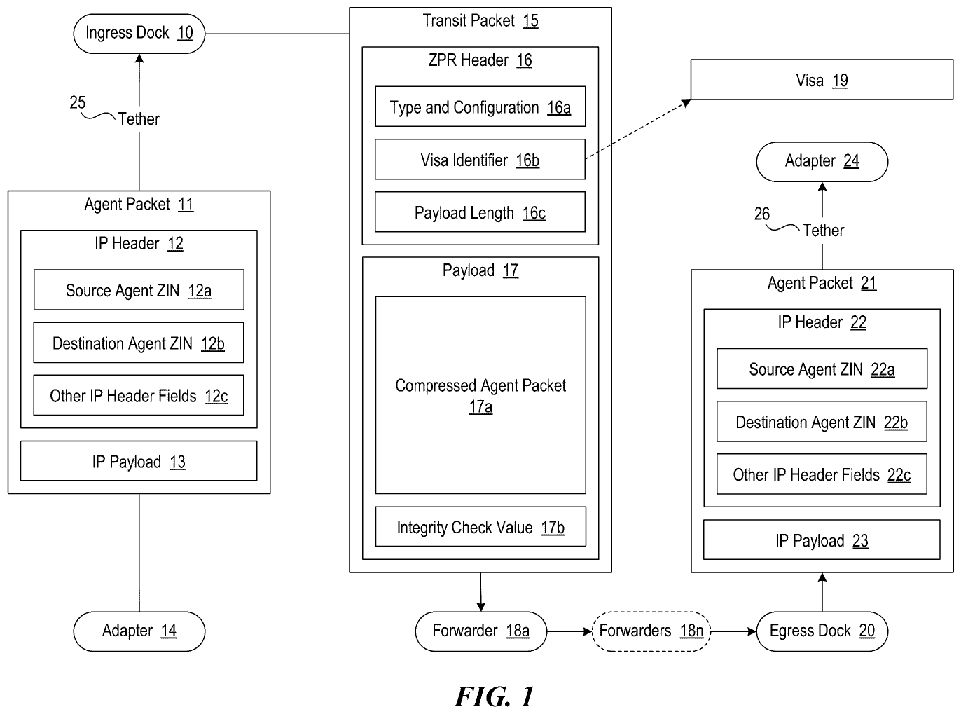

FIG. 1 shows an ingress dock converting an agent packet received from an adapter into a transit packet for transmission through a ZPR network and subsequent conversion to an agent packet by an egress dock according to an embodiment of the invention.

As shown in FIG. 1 the ingress dock 10 receives the agent packet 11 upon entry into the ZPR network through a docking session from a source adapter 14. The agent packet 11 is an IP packet comprising an IP header 12 having a source ZIN 12a, Destination agent ZIN 12b, and other IP header fields 12c, and an IP payload 13. The ingress dock converts the agent packet to a transit packet 15 comprising a ZPR header 16 having a type and configuration 16a, visa identifier 16b, and payload length 16c and a payload 17 including a compressed agent packet 17a and an integrity check value 17b. The ingress dock encodes the information from the agent packet into the payload and the associated visa of transit packet. The ingress dock uses the payload and visa keys associated with the visa 19 to generate the message authentication code through a cryptographic hash.

### Field Sizes are Determined at Configuration Time

ZPR fixes the lengths of most fields at the time of configuration. This is different for the usual convention or fixing field lengths at the time of protocol definition or using variable-length dynamically. Fixing field lengths in the protocol definition is inflexible and variable-length fields require extra run-time overhead. In a ZPR internal packet, only the packet type and configuration fields have a fixed length and position. All other required fields in the header are defined by the configuration and allowed to vary from configuration to configuration. Because internal packets never leave the ZPRnet, each configuration can use a format that is optimized for that configuration. When there are multiple active configurations, multiple packet formats may be in the ZPRnet concurrently.

One of the advantages of defining header-field lengths at configuration time is that the lengths can be chosen to optimize performance of the actual configuration. Default field lengths can be based on the needs of typical configurations, rather than the potential needs of unusual ones. This allows each unusual configuration to be unusual in its own special way. It also allows the default length to reflect only the needs of current networks, without guessing about possible directions of expansion in the future. As use cases evolve, the default field lengths can be expanded where they are actually needed. Based on the needs of current networks, the header overhead of a ZPR packet can actually be less than that of a standard IP packet.

All ZPR internal packets have a format identifier and packet type field, as well as a configuration identifier. A transit packet has a visa identifier, payload length, and payload (with a MICV). A herald packet has a herald type, visa identifier, and visa serial number. A herald-response packet has a response type, visa identifier and visa serial number.

The format of the first few bits of a packet header is fixed. This is to distinguish between different formats that may co-exist within a network simultaneously. The remainder of the header is defined by the configuration to optimize packet processing. For example, current technology more easily supports header fields that are aligned on byte and word boundaries. The visa identifier length can be chosen based on the maximum number of visas that can be held within a single node. The length of the visa serial-number fields in herald and herald-response packets can be based on the maximum number of visas that can be simultaneously active within the network. The number of configurations supported, the size of the payload, and units of payload size can be determined by storage capacities of the hardware. The length of the packet type field can be determined by the number of packet types actually in use.

### Visa Parameters

A visa is a permission issued and stored by the visa service. Visas are unidirectional, so that a visa allowing transmission of a packet from a source tether address (25) to a destination tether address (26) is not the same as the visa that allows transmission of a packet from the destination tether address to the source tether address. Each internal packet is associated with a visa that specifies how it is to be processed and where it travels. The actual stored representation of a visa is determined by the implementation, but it must have certain information, which is described below.

Every visa has a serial number. The serial numbers of all the currently valid visas in a configuration are unique. The visa serial number should not be confused with the link-specific visa ID that can also specify a visa.

Every visa has an associated configuration. This is the configuration in which the visa permissions are applicable.

Every visa has an expiration time. The visa permissions are valid before the expiration time.

Every visa has visa keys. This is a cryptographic key that is used to compute the message authentication codes, and sometime, to encrypt traffic between docks.

Every visa has required field values. The required field values are a set of field-and-value pairs, specifying what values can be in which fields of an agent packet for the visa to be applicable to the agent packet. These may include, for example, address, port, and protocol fields. These are matched against the header of an agent packet to recognize that the visa is applicable. The required field values are also used to governate the compressed representation of an agent packet and to regenerate the agent packet from the compressed representation.

Every visa has required node storage. The required node storage specifies the storage in a node required to hold the visa and to process internal packets associated with it. This storage includes forwarding tables, visa identifier associations on outgoing links, and the storage required to measure the rate and volume of information associated with the visa. This storage is allocated when the node accepts a visa and de-allocated when the node ceases to hold the visa. If different resources are required for different types of network components, then there may be different required node storage, for each class of network component.

A visa has PEPs and PEP parameters, which specify instructions for processing the associated packets in a way that is consistent with policy. The PEP parameters typically specify a destination tether address and allowances. Different PEP and PEP parameters are specified for ingress dock, forwarders (18a-18n), and dock (20). The ingress dock PEP and PEP parameters specify how to covert an agent packet to an internal packet. The egress dock PEP and PEP parameters describe how to convert an internal packet to an agent packet 21 that includes an IP header 22 having a source agent ZIN 22a, destination agent ZIN 22b, and other IP header fields 22c, and an IP payload 23.

Each visa server also keeps track of endorsements of the visa, which indicate which of the n visa servers that implement the visa service have endorsed the visa. A visa is not considered issued until it has been endorsed by at least k servers. It is not considered retracted until enough servers have unendorsed the visa that it is no longer endorsed by k servers.

### Visa Distribution and Identifier Assignment

Only the visa service stores an entire visa. Nodes that have accepted information about a visa and process packets under it are said to hold the visa, but they are only privy to the parts of the visa information that they need. The following discussion describes how that information is distributed to the nodes that hold visas. The reverse operation, by which a revoked visa is retracted from those nodes, follows a similar procedure. Issuance, distribution, acceptance, and holding of visas are distinct operations. Each has a reverse operation, respectively called revocation, retraction, refusal, and de-acceptance and ceasing to hold.

### Heralding

Before the node can send a packet over a link it must establish that the connecting node is holding the associated visa and discover what visa identifier the connecting node chooses to use for the visa. This is accomplished by a process called heralding.

In heralding a node that holds a visa sends a herald packet to a connected node, specifying the serial number of the visa being heralded. Herald packets follow the path of transit packets that are forwarded under the visa. Receiving nodes reply to herald packets with a herald-response packet, indicating whether it has accepted the visa and, if so, what visa identifier it chooses to use for it.

Allowing the connecting node to choose the identifier lets it process the incoming packet more efficiently. It is anticipated, although not required, that the node choose to use visa identifiers that it can use as an index into tables that store information related the visas. To facilitate this, it chooses an identifier that corresponds to an unused entry. It may keep track of unused entries, for example, by storing a linked list of unused entries in the unused positions of the table. If the node has no unused entries it may cease to hold another visa to free up an entry or, alternatively, it may refuse to accept the visa; in which case, it indicates the refusal in the herald-response packet.

Herald-response packets are always sent back to the node that transmitted the herald packet from which they received a visa, on the same link on which it was received. Herald and herald-response may make use of packet checksums, timeouts, retransmission, and other herald-response packet payloads to ensure reliable transmission of the response over the best-efforts secure channel provided by a link. For example, if a herald-response packet is not received within a configuration-determined timeout period it is retransmitted.

A node always ensures that a visa is accepted by a linked node before it transmits a transit packet with that visa to that linked node. The node transmits a visa in a herald packet along the path that a transit packet would travel from the node to the destination. A node may use a hop count field in the herald packet to prevent the herald packet from being forwarded more times than the maximum allowed path length of the configuration.

### Visa Distribution

Visas are issued by the visa service, normally at the request of an ingress dock. To distribute information about a newly issued visa, the visa service begins by sending information to the ingress and egress docks that they need to hold the visa. For a dock, this includes such information such as the required field values, visa serial number and visa keys. The visa service communicates this information to the dock through a secure channel it establishes through the ZPRnet with each dock.

Any visa information required by forwarders can then be sent in one of three ways, called on-demand distribution, proactive distribution, and herald distribution. Each method has advantages and may be preferable in a given situation. In on-demand distribution a node requests the visa service using the serial number of the visa. It makes this request over the secure channel between the node and the visa service. The visa then responds with specific information required by that node. On-demand distribution is the most flexible and perhaps easiest to implement form of distribution. It is especially useful when the need to distribute visa information to forwarders is unexpected, such as when rerouting on secondary paths due to link interruptions.

In proactive distribution, the required information is sent by the visa service over the secure channels to the forwarder that needs it. The is a good method of distribution to a system with a small number of forwarders, especially if it is easy for the visa service to determine which need it. It also may provide lower latency for the first transit packet traveling under the visa.

In herald distribution, the payload of a herald packet carries enough information for any forwarder on the path to derive the information it needs. The payload also carries an endorsement from the visa server in the form of a cryptographic signature. The node can use the signature to verify that the herald packet represents a valid visa distribution or retraction. The disadvantage of the herald distribution is the cost of generating the signature in the visa service and verifying the signature in each forwarder. On the other hand, herald distribution reduces the number of interactions with the visa service and, therefore, may be an attractive alternative for configurations with many forwarders.

### Ceasing to Hold a Visa

When a node ceases to hold a visa, it stops processing packets under the visa and de-allocates any storage allocated to hold the visa. An egress dock also reports the total volume of information that was received under the visa to the visa server. A node may cease to hold a visa for one of several reasons.

When a visa expires, any node holding the visa ceases to hold it. When a visa is retracted, all nodes cease to hold it.

When a node is low on storage it may cease to hold a visa that has not been recently used. In this case, it notifies any node from which it has accepted the visa that it is de-accepting the visa, and not cease to hold the visa until it has received an acknowledgement of the de-acceptance.

### Byzantine ZPR Network Services

Some simplified implementations of ZPR-like networks may use a single visa or admin service, but to fully comply with the ZPR principles, a ZPR network must allow any network component implementing the visa service or admin service to fail or be compromised without impairing these services. Either of these critical services can be implemented by multiple components, called servers, each of which is implemented on a different network component. Fault tolerant services can be implemented on n redundant servers by known Byzantine state replications methods, such as Practical Byzantine Fault Tolerance (PBFT). If there are n servers these methods protect against the compromise of up to (n−1)/3 of the servers. Thus, to comply with such ZPR principles, these methods require four servers. The following is a discussion of the details of how this works.

Byzantine state replication is sufficient to implement ZPR compliant services, but it does more that is required. The requirement to tolerate a compromised server can be more simply accommodated by taking advantage of the specific requirements of each service.

The admin service receives its critical state information only from the admin agent. It only receives reports from other sources. If the admin service can independently decide how to act on these reports, for example in storing them and communicating them to the admin, then servers that implement do not need to interact with one another to make decisions. In this case, the admin service may be implemented by only three servers and service-interaction protocols associated with each node and management service. These service-interaction protocols send the same information to all three servers and only accept information as valid if they receive it from at least two of the three severs. They also report any disagreeing server.

The visa service presents a more complex problem because a visa may be requested for the same agent at multiple docks concurrently. Handling this correctly in all cases requires global coordination of the servers issuing visas, because it depends on an assessment of global resources used by an agent. Also, the visa service may need to share the load of issuing visas across many servers. For these reasons the visa may be implemented by a combination of issuing servers, and service-interaction protocols implemented by each node. A set of at least four state servers use Byzantine state replications methods to hold state information that is shared among the servers. This system allows that the number of issuing servers may be larger than the number of state servers, which may be desirable for efficiency.

Dock communication with the visa service is all through the service-interaction protocols. The client elements maintain secure, reliable connections with at least three issuing servers, and send all requests to these issuing servers. They accept responses to these requests only if they receive matching replies from two servers. If a client element fails to receive a matching reply from a server within an expected period of time, it reports this and ceases to use that server for requests. A client element only sends a request to a dock if it receives a matching request from two issuing servers. There may be other issuing servers that are not involved in the transaction with the client elements.

When an issuing server receives a request for a visa, it determines whether a visa should be issued based on information in the request and information obtained from state service. If there is not a visa that should be issued, it replies with a refusal. If there is a visa that should be issued, the issuer replies with the information, other than endorsement, that should be included in the issued visa. When the client element receives matching visa information from two issuers, the visa is issued with that information and with a specification of the two issuers as the endorsement. That specification may be derived from the ZIN of each issuer by removing the prefix that does not distinguish them.

The requester of the visa is able to determine that the information came from the issuer because it communicates with the issuer through a secure channel, but a node that receives the visa through other means needs another way to confirm that it was issued by the endorsers. Every node has or can establish secure, reliable channels to each issuer for this purpose. This channel may be used by the node for asking for a confirmation from the endorsers or, alternatively, it may be used by the endorsers to send this confirmation in advance to all additional nodes to which the visa may be distributed. In either case, the client element requires confirmation from two endorsers to confirm that the visa is valid. The request or distribution of the confirmation may include all of the information in the visa other than the endorsements, or alternatively a cryptographic hash of this information. The method of pre-sending the confirmation may be combined with the method of requesting the confirmation, with nodes storing only a limited number of pre-sent confirmations in a first-in-first-out buffer, using the buffered information when it is available and requesting new confirmations when it is not. It may be advantageous to send the confirmation of the pair of visas that enable communication in both directions of a flow in the same message.

Either ZPR network service can also receive reports from nodes or management services. When a reporter sends such a report, it sends the request to at least two servers of the service through a secure, reliable channel and it only accepts the acknowledgement of the report when it has received a matching response from at least two servers on these same channels. If it does not receive matching responses within a maximum waiting period, it may send the report to additional servers. It may also report the failure as a separate report.

### Visa Service

The visa service issues visas upon request from a dock and can pre-issue visas before activation of a configuration. Visas can be distributed as part of a configuration or issued at the request of a dock and then distributed. A node always checks that the visa is not expired before using it to process a packet.

Before a dock converts an agent packet to a transit packet it must be associated with a visa. It can obtain an applicable visa from the visa service. To request a visa, the dock communicates with the visa service over its secure channel to the visa service, using the active configuration's visa-service protocol. A request for a new visa includes the source of the header information of the incoming agent packet for which the visa is requested and the tether address of the tether through which the agent packet entered the ZPRnet. Upon receiving a request for a new visa, the visa service records the information that an agent using the ZIN specified in the source ZIN of the header can be contacted at the tether address. It then attempts to determine the destination tether address corresponding to the specified destination ZIN. If no destination tether address can be determined, the visa service refuses to issue the visa.

If the visa service successfully determines a destination tether address, it attempts to find a policy that would allow the agent connected at the source tether address to send packets to the agent connected at the destination tether address. The visa service then attempts to determine the identity of the source and destination agents as specified by the authentication policies of the active configuration. This can require determining the identity of the agents through their adapters (14, 24; see FIG. 1) or from their ZINs. After determining the identity of the addressed agents, the visa service attempts to identify communications policies of the active configuration that would allow those agents to communicate. This can require attempts to authenticate attributes of the agent's identities as required by those policies. If the visa service can find no policies that would allow the addressed agents to communicate, the visa service refuses to issue the visa. If the visa service finds an applicable policy, it issues the visa.

If there are multiple candidate sets of attributes that can satisfy the policies, the visa service attempts to verify the candidate sets sequentially. Preferably the visa service begins with the candidate sets that are more likely to succeed and depend on attributes that are already authenticated or can be authenticated without the interaction with a person. Once the visa service succeeds in authenticating a set of attributes that satisfies the policies, it need not consider other possibly valid combinations of attributes to issue the visa. If the visa service cannot authenticate an acceptable combination of identity attributes or for some other reason cannot issue a valid visa, the visa service refuses to issue the visa.

The visa service determines the appropriate expiration time for the visa based on the current time, the expiration times of the authentications, the authentication time, and any maximum allowed visa lifetime set by communications policies. The visa also calculates the maximum volume of information that the visa should be allowed to transmit during that time at a given QOS and specifies these as allowances in the PEP parameters. In calculating these parameters, it takes into account the volume of the information already sent under previous visas issued to the same compliant flow as reported by the egress docks associated with previously issued visas. If there are previously issued visas that have not yet expired, the service assumes that this visa may permit the maximum amount of traffic that they allow under each QOS before they expire. In some instances, this may result in the service delaying the issuance of a new visa until a previous visa expires and the egress dock or docks associated with it report the volume of traffic that was used.

To issue a visa, the visa service generates a visa endorsement either by cryptographically signing the distributed visa information with its private keys or by transmitting the visa information through secure channels. It also generates and endorses the associated visa ingress data and visa egress data. It then communicates the visa and visa ingress data by a reliable, secure channel to the ingress dock and communicates visa egress data by a reliable, secure channel to the egress dock, and the visa is issued. On receipt of the visa information, the ingress dock holds the visa and the visa ingress data in association with a visa identifier associated with a visa. Similarly, the egress dock holds the visa and the visa egress data in association with the visa identifier. The visa refuses a visa by generating and endorsing the refusal in a similar manner.

The visa keys are used to ensure the security of information transmitted between the ingress dock and egress dock. The visa keys should be updated at regular intervals, for example by the visa server, to prevent the same keys from becoming overused.

The visa service maintains cached state information about the identity, tether address, and the authentication status of the identity attributes of each docked agent; including authentication status of the identity attributes of an agent that indicate if, how and when those attributes were authenticated. When an authentication attempt of an identity attribute is unsuccessful, the authentication status of the identity attribute can be updated to reflect the time and method of failure.

When possible, the visa service determines agent identities and authenticates agent identity attributes based on its cached state information. When such information is not available or has expired, the visa service authenticates the identity attributes of the source and destination agents by interacting with their adapters or authentication services. The visa service may update information from the external service by polling it at regular intervals or receiving updates for the external service. To interact with an agent via an adapter, the visa service uses its reliable, secure channel to the adapter's dock to communicate using the visa-service protocol. Interactions with the dock through this protocol cause the dock to interact with the adapter using the ZIP protocol. Thus, the dock can assist in the authentication-exchange between that visa service and the adapter through which the agent is docked. Failed authentication attempts are reported as specified by the reporting policies.

When the authentication expires, as specified by the authentication policies, or when it is invalidated, the authentication status stored in the visa service is updated to indicate that attribute is no longer authenticated. It is invalidated, for example, if any of the credentials used to authenticate the identity of a tethered agent cease to be honored or if an authentication service retracts a certification. The authentication policies can also cause it to be invalidated for other reasons, such as a change in the state of the trust determined by a trust evaluation service.

The visa service keeps track of all docks to which it has issued a visa. The visa service can send these docks a new visa to replace a visa due to expire soon. If a visa becomes invalidated, for example, because an authentication that it has relied upon to issue the visa is invalidated, the visa service revokes the visa by sending a revocation to all docks to which it has issued a visa of the revocation. A revocation must be endorsed in a manner similar to the manner in which a visa is endorsed. The revocation specifies the visa being revoked, for example, by indicating its previous endorsement.

The visa ingress data and visa egress data also have endorsements, generated by the same method as the endorsement of the visa. These are validated by the ingress and egress docks before accepting the visa.

Preferably, upon issuing a visa, the visa service also issues a second visa enabling communication from the destination tether address to the source tether address. If the visa service cannot issue this second visa, policies can require that it revoke the first visa.

The visa service may generate the endorsement by generating one or more cryptographic signatures signing the rest of the information in the visa, in which case the endorsement can be validated by using the public key or keys of the visa server. Alternatively, the endorsement specifies each of the servers endorsing the visa, and the endorsement is confirmed through secure channels.

### Admin Service

The admin service manages configurations of the ZPRnet, manages other ZPR network services, manages internal adapters for the internal network services, and receives reporting from ZPRnet and other ZPR network services and associated network components. The admin service also keeps clocks on all network components synchronized within policy-determined tolerances using Network Time Protocol. The admin service is connected by a reliable, secure channel to each management service, to each node, and to at least one admin. The admins use trusted tools to compile the policy specifications into the format required by the admin service. They are communicated to the admin service using ZAP.

The admin service may require some form of authentication from the admin to connect to the services and perform operations through ZAP. Following the ZPR principle of not relying on someone who administers the network to behave in any particular way, policies are set up so that configuration changes require the cooperation of multiple individuals. In addition to this service authentication, the network itself will enforce policies to limit communication with the service. To facilitate the application of different policies to different operations, the admin service uses different addresses for different operations requiring different policies. The network can then enforce different policies to access these different types of operations.

One of the functions of the admin service is to distribute and switch configurations, which it accomplishes with the assistance of management services associated with the network components. Configuration announcements may be implemented through a ZPR network by way of a broadcast or multi-cast flow. Node numbers may be chosen to make it easy to target certain targeted announcements, such as announcements to internal docks on a certain type of network component. In effect, a field in the node number can represent the announcement target.

The admin service manages configurations. When a ZPR network is initialized, the status of one configuration is ACTIVE, and the status of all others is UNDEFINED. Any configurations that have UNDEFINED status can be edited by specifying incremental changes. For efficiency, ZAP also allows any UNDEFINED configuration to copy information from any DEFINED, TESTING or ACTIVE configuration and then set its status to UNDEFINED, allowing incremental updates to existing configurations. Once a configuration has all the required associated information, ZAP allows the status of the configuration to be switched to DEFINED. ZAP also provides a way to switch the status of a DEFINED configuration to ACTIVE or TESTING and a way to switch a TESTING configuration to ACTIVE.

It is possible to test a defined configuration, referred to as the test configuration, before making it the active configuration by setting its status to TESTING. When an agent packet is processed by the ingress dock in the active configuration, a dock may also process the packet as if the test configuration was active, generating an internal packet called a test packet. The test packet's visa is associated with the test configuration. When the egress dock processes a test packet, it does not actually deliver the reconstructed agent packet, but merely checks it would have been delivered to the same destination in the test configuration as it was in the active configurations. If there is any difference, that difference is logged. This allows a new configuration to be tested to determine which packets delivered or discarded in the test configuration would be discarded or delivered in the active configuration. It also allows visas used by the test configuration to become issued and distributed in advance of the test configuration becoming the active configuration.

A ZPR network may also limit the rate at which the visas associated with a test configuration are issued, distributed, and tested. A test packet does not need to be generated for every agent packet processed in the active configuration. For example, a dock may wait for a period of time after the test configuration status is set to TESTING before such a visa is requested and may use its node number to select that period of time so that different docks begin testing at different times.

Once a dock has requested a visa in the test configuration, it may not generate further test packets for a period of time after it receives a response to that visa request. Once a dock has sent a test packet using a visa, it may not use that visa to send further test packets. These methods limit demands made on the ZPRnet by the testing and visa distribution of the test configuration.

Before switching the status of a configuration to ACTIVE or TESTING the admin service causes the allocation of any required resources, the loading of any configuration-required resources into the appropriate network components, and the creation of any communication sessions required to activate the configuration. If the configuration's status is later changed from DEACTIVATING to DEFINED, then these resources are automatically de-allocated and any sessions associated with disestablished links are disestablished, unless they are required by another configuration with ACTIVE, TESTING, or DEACTIVATING status.

### ZPRnet Namespaces

Each ZPRnet is configured with a ZPRnet identifier space, which defines the portion of the IPV4 and/or IPv6 address spaces which are accepted as ZPRnet identifiers by that ZPR network. A ZPRnet identifier space may be defined, for example, by a set of address prefixes. It is not necessarily contiguous and may include both IPv4 and IPV6 addresses. Packets transmitted through a ZPRnet must have source and destination addresses in the ZPRnet identifier space of that ZPRnet. To receive such packets, agents must either be directly connected to that ZPRnet, or reachable through the ZPRnet, such as through a gateway to another network.

A ZPRnet identifier space may include portions of IP address spaces that have public IP addresses or specific private IP address spaces. It may include both addresses that are statically assigned and assigned dynamically via DHCP-like mechanisms. Operating systems of computers that communicate through a ZPRnet automatically direct packets addressed to a ZPRnet identifier space through the ZPRnet associated with that ZPRnet identifier space.

For back compatibility, a portion of IPV6 global address space, called the ZIN namespace, is globally allocated for publicly known ZPR addresses, including IPV6 addresses corresponding to each IPv4 address. The Unique Local ZINs can be allocated in this space. The ZIN namespace uses one or more globally reserved ZPR Reserved Prefixes of the IPV6 address space, making ZINs distinguishable from other IPv6 addresses.

As with other private IP networks, ZPR administrators may select portions of the IP address space that do not conflict with other addresses used on the network, for use as private addresses for the ZPRnet. Just as IP globally reserves portions of IP address space for private addresses, ZPR globally reserves a portion of IPV6 space for private ZPRnet addresses, called the Unique Local ZINs. ZPR cannot depend on use of the same spaces that are reserved for private IP addresses, because it may need to handle packets from IP networks that are addressed with these addresses. It may also globally reserve a (presumably small) portion of the IPV4 address space for use as Unique Local ZINs.

Each ZPRnet includes at least a portion of the Unique Local ZINs and other identifiers from the ZIN namespace in its ZPRnet identifier space. In addition to usual allocations for static and dynamically allocated addresses, these identifiers are used for dynamically assigned ZINs, and ZPRnet service identifiers, for example for the visa service, admin service and the management services. The policies only allow these services to communicate with other internal systems.

Dynamically assigned ZINs provide a way for an agent without an allocated ZPR address to send a packet through ZPRnet and get a reply to it through the ZPRnet. They may be used for example, by an agent with a publicly registered IP address that is referenced by a ZPRnet policy, or by an agent needing to obtain an address in the ZPRnet identifier space by contacting a DHCP server through that ZPRnet. Because IP addresses that are not ZPR addresses have no meaning in the network outside of the context of the tether on which they enter the network, dynamically assigned ZINs are allocated by the visa service whenever a visa is issued for a packet with a return address outside of the ZPRnet identifier space. The dynamically assigned ZIN is associated with the tether on which the packet entered the network. When the visa is issued for agent packets with a ZIN in the destination field outside of the ZPRnet identifier space, that visa is issued with egress visa data that causes the IP address to be substituted in the reconstructed agent packet to be delivered. When a return visa is issued for agent packets with that dynamically assigned ZIN in the destination field, that visa is issued with egress visa data that causes the original IP address to be used in the reconstructed agent packet delivered through that tether. Alternatively, the egress nodes could reconstruct the packet as transmitted and then perform a full Network Address Translation (NAT).

Externally-accessible ZPRnet service identifiers are used to access services provided by the ZPRnet itself, not restricted to use internal to the network. For example, one such service that is provided by every ZPRnet is an address registration service, that allows an adapter to announce that it is ready to receive packets through a particular tether for a specified ZIN. Packets addressed to the externally-accessible registration service from the address to be registered are interpreted as registration requests. When such packets enter the network and are successfully issued a visa and, if required, a dynamically assigned ZIN, a confirmation is delivered back to the source to confirm that it has registered successfully. Because the issuance of the visa requires that the registration is allowed by policy and that any required authentications have been performed successfully, this only registers attachments that are specifically allowed and authenticated according to policy. Note that it is possible to implement such a registration service as a distributed service simply with PEPs for the policy that handles such packets addressed to a Loopback Identifier.

Another externally-accessible ZPRnet service address that may be provided is a DHCP service that issues leased addresses in the ZPRnet identifier space.

There are other address spaces associated with a ZPR system, which have address spaces that are not a part of the ZPRnet identifier space. Internal packets are delivered using the tether address space, which are related to the node numbers defined by the configuration. Tether addresses are not visible outside the network, nor are they explicitly represented in internal packets. They are derived from the visa. Also, as described earlier, links and docking sessions may be implemented on one or more substrate networks, each with their own address space. These networks and their associated address spaces may or may not be visible outside of the ZPR system, depending on whether other types of traffic are carried on those substrate networks.

### Docking

A docking session is established in a ZPR network through a dock by a process called docking, which connects an adapter to the ZPR network. When the adapter and dock are implemented as functional modules with the same network component, the docking session can be implemented as an internal hardware connection. When the adapter and dock are through a network, docking requires a way for an adapter to receive the network address of a dock, called a docking point.

The docking connection policies specify what protocols are supported for docking, and the suite of supported protocols is expected to evolve over time. The following discussion describes some general characteristics that are shared by many or all of these protocols.

If the adapter and dock create a docking session through a network, the dock must limit the resources used in handling requests to establish docking sessions. For example, the dock may ignore such requests for a certain period after it handles a request, require some proof of work on the part of the docking adapter, or use docking points that can only be predicted with access to a secret shared between the adapter and dock. The dock and adapter also must authenticate one another which may be done by a variety of methods, usually involving some form of cryptographic authentication. They may also establish some method of maintaining their connection if the location or network address of either adapter or dock changes.

If the connection between the adapter and dock is not a secure channel, they must establish shared cryptographic keys, for example, by a Diffie-Hellman key exchange.

A docking session can be established to a dock when the adapter is first initialized or is woken up, similar to other network interfaces. A docking session persists until it fails or is disestablished by the adapter or the dock under circumstances specified by the policies. If the docking session fails it is reestablished when the adapter or dock needs to communicate and as permitted by docking connection policies.

An agent can inform the ZPRnet that it is available to receive packets addressed to a specific ZIN. This may be accomplished through ZIP or by sending a message to the Loopback ZIN.

### ZPR Devices

There are several types of ZPR devices that can be used as components of a ZPR system. These have optical or wired communications interfaces, as well as interaction interfaces such as keypads, card readers, microphones, displays and face, fingerprint, voice, and other recognition systems. They may incorporate processors with firmware, software, or other programmable elements and store this information in programmable read-only memory. Such devices may be used to implement components of a ZPR network such as docking sessions forwarder, services, and servers.

A single IP network interface on such a device can serve as both an adapter-facing interface and an ZPR-network-facing interface. It might also include ZPRnet interfaces and agent-facing interfaces.

A ZPR-native device is managed by the network and may include an adapter and dock with an internal docking session between them. In addition to the normal function of these components, a ZPR system native device can have the functionality of a phone, video game, security camera, personal computer, or other type of appliance that can be facilitated by means of communicating directly with a ZPR network via a link.

Any ZPR device may provide a means of proving an attribute of the identity of someone who has physical access to the device, such as a keypad, a card reader, a facial recognition system, or a fingerprint reader, as a condition of programming the device or the use of one or more physical interfaces on the device.

Another optional addition to any ZPR device is a means of determining the physical location of the device, for example by GPS or by attempting local communication with other devices that are expected to be in the vicinity.

### External Policies

Not all policies associated with a ZPR system are enforced by the ZPR network. Policies not enforced by the network are called external policies. External policies are not part of the ZPR system, but their enforcement can be required for its successful application. A ZPR system can be supported by credential-issuing services, trust evaluation services and other services external to the ZPR network. In many cases, agents are able to communicate with these external services through the ZPR system, in which case the ZPR system can be useful in maintaining the integrity of these external systems, but it cannot in itself ensure it.

Below are some examples of reliance on external policies. These policies and their method of enforcement can vary across different ZPR systems. A ZPR system can rely on external policies for issuing, validating, distributing, revoking, and controlling access to credentials, and for informing the admins of relevant changes in their status.
A ZPR system must rely on external policies to ensure that appropriate software images are initially loaded into network components.
A ZPR system may rely on an external trust evaluation service. The methods used for evaluating trust can depend on the information gathered from network traffic, and from other sources, to compute a trust score for an agent. The specific methods of trust evaluation are a matter of external policy.
A ZPR system may rely on external policies for allocating addresses within the static portion of the ZPRnet identifier space, either separately or in conjunction with names and/or credentials.
Admins must rely on external policies to establish and maintain the integrity of their trusted admin tools. Trusted admin tools can rely on information in external databases, such as personal and equipment databases or directories, to create a policy specification. For example, the policy description language can reference the information in these databases. External policies are relied upon to protect the integrity of these databases.
Admins also must rely on external policies to make sure they are defining valid policy for the ZPRnet. External policies can also restrict how configurations are managed. For example, as described above, ZPR networks allow a new configuration to be tested before it becomes active to help ensure that the new configuration will not cause unintended disruption of services. External policies can specify when and how much such testing should take place before activating a new configuration.
   How would an Enterprise Use ZPR?

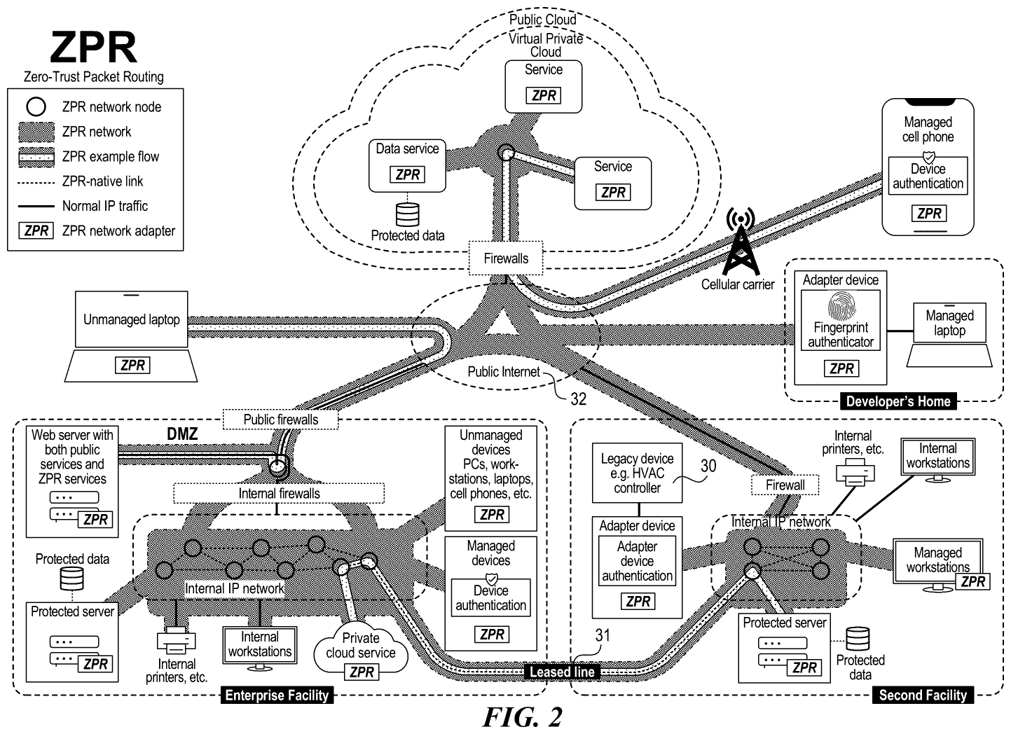

FIG. 2 shows an example of how an enterprise might use traditional IP networks and ZPR networks concurrently to implement a secure Wide Area Network (WAN) according to an embodiment of the invention.

In FIG. 2 some of the ZPR multipoint links are made through existing IP networks, others used dedicated ZPR channels. In this example, critical servers and data are protected behind a ZPR network either inside the company's facilities or in the cloud. Policies limit access to services, whether they are hosted in company datacenters or on external clouds. Policy also limits the communication between services. The result is that a compromised user or device is unable to probe for information or communicate with servers that it is not specifically permissioned to access.

Most devices shown are connected by software ZPR network adapters (ZPR). Legacy devices such as the HVAC controller 30 are connected through devices that contain adapters. Some devices connect to a ZPRnet through IP networks, others connect to it directly. In this example, the enterprise has two facilities that are connected by a leased line 31 which only carries ZPR traffic, with a redundant path available through the public Internet 32. Normal firewall and the end-to-end protection is left in place.

### How ZPR Works

ZPR creates an identity-aware network security layer, called a ZPRnet. It allows enterprises to enforce security policies uniformly across all their systems and users. It works seamlessly on-premises, in clouds, and over remote connections. The policies are based on the authenticated identity and attributes of both the communicators and the communicated data. Just as IP enables networks to cooperate in delivering packets, ZPR enables networks to cooperate in enforcing the shared security policies. ZPR is fast and simple enough to implement in software or hardware. ZPR can use standard IP and requires no changes to existing applications and networks.

The following discussion describes how ZPR works, with a focus on how policies are defined, distributed throughout the network, and enforced each time a packet is forwarded.

### How Policies are Defined

ZPR policy language, called ZPL, is used to specify what packets are allowed to travel over the network (permissions), and the intent of policies (assertions), that verify that policies are implemented as expected. ZPL is optimized for readability by human policy writers and auditors. ZPL is compiled into a format that is efficiently used by ZPR at runtime. Although policies expressed in other languages could also be complied for a ZPRnet, other languages may not be able to express all of the policies that a ZPRnet can enforce.

In ZPR, the senders and receivers that communicate through the network are referred to as agents. Agents may be people, devices, software services or combinations of these, such as a person using a specific device, or a service that is implemented by a group of servers. Agents have an authenticated identity which has associated attributes, such as the roles of an employee or serial number of a device. Communication policies in ZPL are stated in terms of attributes of agents, of the data they're communicating, and the circumstances at the time of communication.

All communication on a ZPR network must be specifically allowed by a permission statement. To make the policies easier to understand and audit, all permission statements are positive allowances. ZPL provides no way for one statement to add an exception to another. The advantage of this is that the policy consequences of each statement can be understood independently of context.

For example, a permission statement might allow the network to communicate classified information between government employees, with the proper clearances, and classified database services, connecting through authorized devices, while they are located within a government facility, unless they have exchanged more than 100 megabytes of information in the last 24 hours. In this example, the communicating agents are each a combination of a person and a device. The employment status and clearances are attributes of the people, and the approval status and location are attributes of the device. The amount of data that has been recently communicated is a local circumstance. The limitation on the amount of data transmitted is a condition.

Policies written in ZPL also describe the intent of the combined permissions-what should and should not be allowed. This is accomplished with assertions. For example, an assertion might state that no classified information should be communicated to agents outside of a classified facility. Such an assertion does not change the permissions. It specifies a way to automatically check that the permissions are consistent with the intent. If they are not, ZPR will not accept the inconsistent set of policies. If unintended communication is attempted an assertion can create an alert and optionally block the communication. Assertions are always checked for consistency with permissions when ZPL is compiled. They can also be run at any time to check that attributes that have changed are still policy compliant.

ZPL can express any network policy that could be implemented by conventional methods such as firewalls, NATs, VLANs, etc. but it can also express much more. For example, it can express policies that depend on attributes of the data communicated, or on global measures of communication, such as limits on the amount of information an agent can move out of a facility during a specific time period.

### Policies Depend on Attributes and Circumstances

ZPL allows different types of agents, each with specific defined attributes. Attributes are defined by name, type of value, default value, and mutability. The type of value can be a set of elements of a given type. For example, an agent that is an employee might have an attribute named Employee-ID-number that has an immutable ID number as a value. An employee might also have an attribute named mobile-devices with a mutable value that is set of mobile devices, such as {cellphone-6789, laptop-2468, tablet-1357}. As in this case, elements of the set may have attributes of their own. Typical attributes include type, names, roles, group membership, capabilities, identification numbers, and public authentication keys.

The identity of the agent is an attribute of the agent that is unique, immutable, and authenticatable through one or more authentication services. Each agent has an authentications attribute which is the set of currently valid authentications. In the case where the agent is a combination of other agents, such as the combination of a person and device, the identity is the union of the identities of the component agents. For example, an employee connecting through a managed laptop might have an identity with two immutable attributes named Employee-ID-number and Device-serial-number. Authentication of such a combined identity requires authentication of each of its components.

Identities are primarily used for authentication, logging, and looking up attributes. Policy is normally written in terms attributes, rather than individual identities. While it is possible to write a separate permission for each individual to access a company resource, it is more efficient and readable to allow access to all agents that have a specific group attribute.

Circumstances are like attributes in that they have a name and a typed value, but their values are transient and can always be determined by local information. The time, date, and measures of the amount of data recently communicated are examples of circumstances.

### Policy Language (ZPL) Examples

A permission for agents with an attribute named “clearance-level” that has a value of “top-secret” could be expressed as follows:
Allow agents with clearance-level top-secret access to resources with classification top-secret over links with government-approval approved to agents with clearance-level top-secret.

For example, the assertion that no vendor should be allowed to access data classified as proprietary could be expressed in the policy language as follows:
Alert and block agents with personnel-category vendor access to resources with classification proprietary.
Assertions may also be made about the allowable values of attributes.

An assertion that each device must have at least one manager could be expressed as follows:
There are no devices with managers { }.

There are also simple ways to express assertions to limit the number of members in a group or to disallow a person to hold two roles that are incompatible.

### Policy for an Enterprise

The sheer size and complexity of large organizations often requires delegating portions of networks and application management to different groups. For example, local permissions may be added by a local administrator. ZPL supports hierarchies that allow delegation, while still enforcing all assertions.

Because ZPL statements are not modified by context, ZPL policies can be hierarchically combined from several sources to create a ZPRnet's global policy. To support this, ZPL provides an inclusion mechanism for combining ZPL-format source files maintained by different parts of the organization. All permissions are combined and tested against the constraints of assertions higher in the hierarchy, with enterprise-wide policies at the top. Permissions can never conflict with other permissions because they are additive, but they might conflict with assertions. Such conflicts must be resolved before a new policy is accepted.

The combined policy file includes all the policy permissions and assertions in a form that is convenient to read and audit. The combined file is compiled into a policy descriptor which is also human readable but is in a more structured format that is optimized for machine processing. During compilation of the policy descriptor, the permissions and current attribute values are checked for consistency with the combined assertions of intent, and enforcement capabilities of the nodes. If they are not consistent, the inconsistencies are flagged, and the compilation does not produce a policy descriptor.

Assertions should be tested against changes in attributes values, for example when users and groups are modified, when machines are modified, etc. This can be accomplished by running tests on assertions at regular intervals, or by having trusted services report when relevant attributes are changed. Assertions may also signal and optionally block unintended communications.

### Trusted Services

The values of attributes can come from trusted services that are specified in ZPL as familiar. Trusted services may include existing directory services, an identity management system, or infrastructure service such a trusted time service. Values provided by trusted services have expiration times. An API is provided for a service to notify ZPR when values change before their expiration time.

The attributes of communicated data may be determined by attributes of the data source, or by tags on the packets that are transmitted by a trusted data source.

Local circumstances are evaluated each time they are used to make a decision.

### Configurations

Policies are part of a ZPR network's configuration, so changing policies require reconfiguration. Conventional network reconfiguration often creates security vulnerabilities. ZPR provides a secure method of network reconfiguration that is managed within the ZPR network itself. This helps protect the network from temporary vulnerabilities during reconfiguration, as well as from misconfiguration by careless or malicious administrators.

ZPR allows configurations to be changed while the network continues to operate. Packets will continue to be transported through the network via the policies of the configuration under which they entered the network. This means that multiple configurations may operate concurrently during a changeover.

### Components of a ZPR Network

A ZPR network consists of a set of communicating nodes and internal services, including a visa service and an admin service. Nodes can include docks and forwarders in any combination. Docks allow agents to connect to ZPRnet through standard IP networks or by direct connections that use IP protocols.

Forwarders move packets between nodes within the ZPR network.

ZPR defines protocols for node-to-node communication. Nodes send packets to other nodes through ZPR communication links that may be virtual or physical. Packets can travel between nodes through a sequence of links, called a path, and policy is enforced by the forwarding nodes at each step along the path. Such a link might bridge a private cloud node to another in the same ZPRnet. Another link might extend the ZPRnet to dedicated servers in an enterprise data center.

Each ZPRnet has its own communication policies, and every node of the network enforces those policies. For example, in a cloud where a smart NIC is attached to a computer that is running multiple computer instances, the smart NIC can act as a node with both dock and forwarder functionality. So, each time a packet passes through a Smart NIC it would be checked against policy.

It is always possible to write policies that cannot be enforced on a particular network, for example, if there is no trusted source for an attribute that a permission depends upon. A ZPRnet always verifies that it can enforce a set of policies before accepting them.

Another example is a cloud provider that implements a ZPR-compatible cloud tenancy, using micro-segmentation for internal policy enforcement. Such a mechanism might not be able to enforce bandwidth limits on traffic within the tenancy, so a ZPRnet including the tenancy would not allow policies limiting those bandwidths.

### Connecting to a ZPR Network Using Standard Internet Protocol

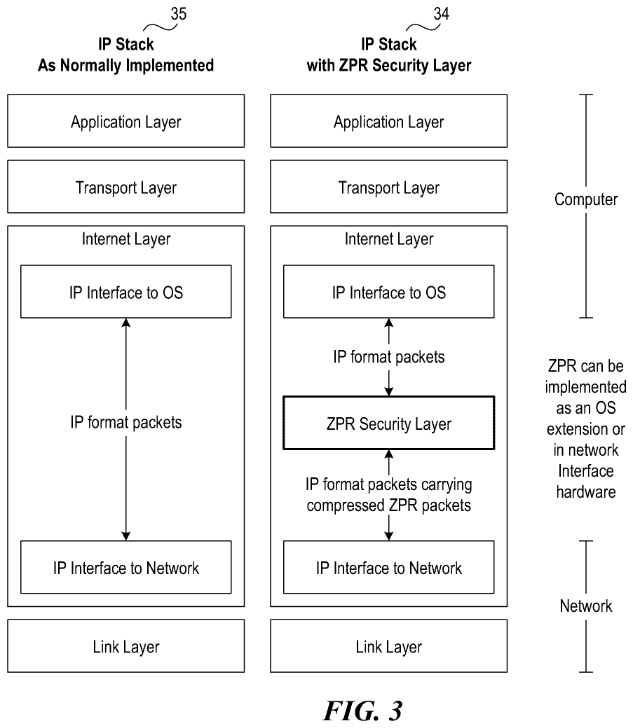

FIG. 3 shows how ZPR fits in the IP Stack 34 at the level of the network interface, which may be software or hardware, according to an embodiment of the invention. A standard IP network 35 carries compressed ZPR packets encapsulated in IP packets.

Agents connect with a ZPRnet via a dock using a secure channel called a docking session. The secure channel may communicate through a direct point-to-point connection, as in the previous example where a smart NIC attached to a system is the dock, or using a tunnel through a standard IP network, as in the case where a user is connecting to a ZPRnet over the public Internet.

In the former case an adapter is used to enable IP-based applications to communicate through a ZPRnet without modification. Adapters can be implemented as operating system extensions or virtual network interfaces that present standard IP interfaces to applications. Adapters create a secure connection to the dock and can handle the requests for identity information from the dock.

The docking session adapter associates the agent's communications with the agent's authenticated identity. For example, when a person connects to a ZPRnet remotely, the adapter allows the device to prove its own identity as well as the person's identity to the ZPRnet. The remote device and its adapter do not enforce policy or even know what policies are, and they are not trusted components of the ZPRnet.

Because all traffic that implements a ZPRnet flows over ZPR, the visa and administration services and all trusted services are agents within the ZPRnet and communicate over it just as services and users do.

### ZPR Operates at the IP Layer

Communication between ZPR nodes occurs at the Internet Layer of the network stack, which roughly corresponds to Layer 3 in the OSI 7-layer model. Because of this, everything that is built on top of IP, including TCP, UDP and all the higher-level protocols that are built on top of these, can work on ZPR without modification. ZPR can run directly on dedicated links, or as an overlay on top of IP.

### Visas

One of the security advantages of ZPR is that every node enforces policy without distributing the policy to the nodes. Most of the work related to determining the policy compliance of a flow of packets is done only once when the permission for the flow is granted. That permission is called a visa, and it is issued by the network's visa service. The visa service distributes a small amount of information to every node that will handle the packets traveling under a given visa. The visa identifier in the header of each packet specifies which visa allows and restricts its travel through the network.

When an agent sends a packet to another agent, the packet first goes to the dock where the agent has a docking session. That dock checks if there is an existing visa for the packet, and if not, it requests one from the visa service. The visa service uses the attributes of the sender, receiver, and data, as well as circumstances, to see if policy allows the packet. If so, a visa is issued, and the appropriate information is distributed to the necessary nodes so that the packet is approved as it traverses the network. If the packet is not allowed by policy, the visa service records the event and notifies the dock to reject the packet.

Visas are point-to-point and allow a specific authenticated agent to transmit packets to another authenticated agent under specific circumstances. These circumstances depend on the time of the communication and may depend on other local state information in the nodes that process the packet. For example, a circumstance may depend on the amount of traffic of a particular class that has recently been transmitted through the node.

Each visa has an expiration time. It may also be revoked by the visa service. The permission granted by a visa terminates when the visa expires or is revoked.

Nodes in a ZPRnet are connected by communication links. The visa identifier used for a given visa is established locally on each link, so the identifier for a given visa may vary from link to link. Visa information is pre-distributed along the sequence of nodes that a packet may traverse, and the visa identifiers are established as part of that distribution. The distribution mechanism can also dynamically establish new paths as required.

### Distributing Visa Information

Only the visa service stores the entire visa. The visa service distributes information about a visa, but only to the nodes that require it and those nodes are given only the information they need to process packets traveling under the visa. For example:
In the case of a forwarding node, this is just the outgoing link to which the packet should be forwarded, the incoming links on which it is allowed to arrive and the local circumstances that need to be checked before forwarding.
The ingress node of a packet is also given information sufficient for converting an IP packet into its compressed form and a secret key for generating a visa-specific Message Integrity Check Value (MICV).
An egress node is given the information required to check the MICV and recreate the original IP packet.

The visa identifiers allow very simple enforcement of a packet's compliance with policy. The translation of policies into network-specific enforcement procedures is done at the time a visa is issued. This simplifies enforcement when packets that reference the visa are being processed. A node is not aware of most of the information in the visa. It need only be in compliance with local conditions and the direction to forward the packet. These can both be quickly determined from the visa identifier in the packet's header. This means policy enforcement and forwarding can be done very rapidly on a general-purpose computer or on hardware that is optimized for packet processing.

### Advantages of Visas

Visas are critical to ZPR security because they bind each packet to its authentication and permissions. The same visa that determines how the packet is forwarded also certifies the authenticated identities of both the sender and receiver as well as the required conditions for travel. The same visa that determines the path also specifies the conditions to be checked at each hop, so the delivery of the packet confirms that it is compliant with policy.

The use of visas has several advantages in ZPR:
Binds each packet to the authenticated identity of the sender and receiver, and to the conditions of travel.
Enables very efficient packet processing using the visa identifier.
Connects the packet to a secret key that allows the receiver to detect if the packet was tampered with or forged.
Allows new policies and network topologies to be tested and adopted while a ZPRnet continues to function and enforce policy.
Makes efficient use of bandwidth since most of the typical IP header packet is not sent in the packet.
Enables rapid revocation of a visa, blocking in-transit traffic permissioned by the revoked visa.
Enables bandwidth reservation and limits by globally tracking the number and size of messages associated with each class of traffic and distributing local bandwidth constraints to the nodes.

### Compliant Flows

ZPR enforces communications policies by creating a specific type of tamper-proof secure channel between agents called a compliant flow. The ZPR network automatically establishes a compliant flow for any policy-compliant communication between agents. Every ZPR packet on a compliant flow has an associated visa that must be valid while the packet transits the network. The packet-processing procedures specified by the visa route the packet to the correct destination and enforce policies as it travels on the flow.

The procedures are applied each time the packet is forwarded, ensuring that the policy enforcement reflects changing conditions and changing attributes. Thus, the compliant flow is compliant in both senses of “compliant”: it conforms with policy, and it can also adapt to changing conditions such as the availability of network resources. This contrasts with conventional network sessions, which typically enforce policy only when a new session is established. A compliant flow may use multiple visas associated over time, or even at the same time. This allows the flow to outlast the expiration time of an individual visa.

All packets in a compliant flow do not necessarily travel across the same path through the network, but ZPR implementations can take advantage of the fact that they often do.

Compliant flows are unidirectional, so they are typically used in pairs to create bidirectional flows. Most compliant flows are agent-to-agent, but ZPR also supports other types of compliant flows such as multicast flows with multiple egress points and combining flows with multiple ingress points. Combining flows merge packet streams with associative payload-combining functions, such as integer addition or bitwise AND, as they meet each other in transit. Multicast and combining flows can be useful in implementing map/reduce computations in high-performance computing and transport-layer multicast.

In some cases, policies route packets through a series of compliant flows. For example, when remote users access a web service, there typically are some type of load-balancing service gateway between the users and the servers. Packets would travel first over a compliant flow from the user to the service gateway, and then on a different compliant flow from the service gateway to one of the servers. The visas on the first flow permit the communication between the user and the service gateway, whereas the visas on the second flow permit communication between the service gateway and the servers. This also eliminates the need for a distinct visa for each user/server pair.

Compliant flows are Internet-layer protocols that carry packets on a best-efforts basis, permitting them to discard packets. They are defended against tampering, but they have no mechanisms for flow control or retransmission. ZPR uses transport-layer protocols, such as TCP, to establish reliable secure channels between nodes and internal services over compliant flows. For example, communication between the nodes and the visa service takes place on reliable secure channels established over compliant flows.

### Design Principles

ZPR is designed based on four paranoid design principles:
1. Every packet must have an authenticated sender and receiver.
2. The network itself must enforce communications policies continuously and throughout the network, not just when packets enter and leave or when sessions are established. Every packet must be discarded unless it is explicitly allowed by a policy.
3. The users of the network, the devices that implement the network, and even the individuals who administer the network must not be trusted to always behave in any particular manner. It must be possible to implement the network so that policies are enforced correctly, even if one of the network components becomes unreliable or compromised.
4. The network is configured and managed as a unified resource, through the network itself.

The security value of the last principle may not be obvious, but it is one of the most important security principles of ZPR. By disallowing out-of-band management and forcing all management to be policy compliant, a ZPRnet can protect itself from accidental or deliberate misconfiguration. For example, it is possible to have a network-enforced policy that requires concurrence of three authenticated administrators from different facilities to activate a new configuration.

An important security advantage of ZPR is that it does not depend on out-of-band communication for administration. The secure channels for internal communication are distributed to each node before a configuration becomes active, through the previous configuration. Cryptographic keys are regularly updated through these same secure channels. The only out-of-band communication required is the original startup of a ZPR component, when it is preloaded with cryptographic material that allows it to join the network. Even this step can be protected by requiring a set of keys that is not fully known to any single administrator.

ZPR's limited trust in its own components also limits the damage that can be caused by tampering with a component. Global information about the policies and traffic pattern of ZPRnet is invisible to the individual ZPR nodes, which are only given the specific information they require to process the packets that pass through them. An adapter is trusted only by the specific agents that use it to communicate. It has no knowledge of network configuration, traffic, connection status or policies of other agents. It does not even have knowledge of the policy related to the agents that connect through it, other than an ability to observe when they can successfully communicate.

### ZPR Policy Language (ZPL) and ZPR Policy Format (ZPF)

The policies that are used to issue and populate visas and for regulating traffic is expressed in a human readable language called the ZPR Policy Language (ZPL, pronounced “zipple”). ZPL is compiled into the machine readable (and human inspectable) ZPR Policy Format (ZPF, pronounced “zipf”). ZPF is used by visa servers to issue or refuse visas.

The following discussion defines what ZPL, ZPF, and the lifecycle events (version control, compiling, deployment, etc.) need to do.

By default, ZPR networks do not allow any communication unless a policy allows it. Connection policies determine if an agent/adapter can talk with a dock. Communication policies allow packets to flow between agents. Authentication services check to see if an agent or adapter has secret information to prove their identity and other attributes. Data sources provide attributes about agents and other components to be used by policies to determine if visas should be issued. Data sources may be external or internal.

### Definitions

Allowance—A bit-limit, a time unit, and a priority. It allows packets to be forwarded up to the specified bit-limit per specified time unit, with the specified priority.

Attributes—Data about agents, adapters, and docks. This can include group membership for users, machines, services, etc.

Authentication Service—Services used by the visa service to challenge and authenticate agents and adapters.

Communication Policy—A collection of scope, conditions, and allowance. A visa can be generated for packets that match the scope if all the conditions evaluate to true.

Condition—A predicate that operates on agent attributes, ZPR data sources, external data sources, and constants used by the visa service to decide if a policy's requirements are fully met.

Connection Policy—A policy that controls which adapters can talk to ZPRnet docks.

Data Source—The internal and external data sources that provide attributes for policies.

Duration—Amount of time a data source or policy is valid for.

Expiration—The time a visa expires.

External Data Source—Sources of data external to ZPR, e.g. LDAP, Active Directory, entitlement servers, etc.

Header—a packet header consists of IP fields and protocol fields.

IP Fields—bit/byte fields associated with IP traffic (source, port, target, port, protocol).

Internal Data Source—Sources of data internal to ZPR. This is the same as ZPR data.

Protocol Fields—Fields in a header that are specific to a protocol.

Scope—The required field values of visas for matching policies with communication requests (protocols, address range, port range, etc.).

Visa—A cryptographically signed permission slip used by nodes to determine that communication is permitted, with what allowances, and until expiration.

Visa Server—A component (server) on the ZPR network which handles visa requests by issuing or refusing to issue a visa.

Visa Service—The service provided by a collection of visa servers on a ZPR network.

ZPF—The low-level ZPR policy format that is distributed to visa servers to decide if a visa should be issued and what allowances and duration are included in the visa.

ZPL—The high-level, human readable language used to express policies and external data sources.

ZPR Data—Data provided by ZPR components and adapters (e.g. connection request, user, device, and node information).

### How a Visa is Issued or Refused

Before any traffic can flow on ZPR, there needs to be one or more policies that determine if the traffic is allowed or denied. A communication policy consists of a scope, i.e. the range of address, ports, and protocols that define the packets that the policy applies to. The scope is used to decide if a policy applies to connection requests. If there are no matching scopes, the connection request is refused.

Once a policy is deemed applicable, there are more hurdles that must be passed. Each policy has a list of conditions that must all be met before a visa can be issued. These conditions are predicates that can be used to limit who gets a visa, what level off authentication they must provide, where they can connect from, valid devices, etc. Conditions can operate on data that comes from ZPR, or data that comes from external data sources, e.g. LDAP, Active Directory, entitlement systems, etc.

The visa service must understand how to connect to external data sources so ZPL (and ZPF) provides functionality for doing this.

If one or more policies match in scope, and conditions, it is time for a visa to be issued. Policies can contain maximum duration, and allowances, i.e. statements of bits/time and priority. ZPL (and ZPF) provide a way to declare these things, and visa servers know how to combine them.

A step-by-step example can help illustrate how this works. For this example, we'll call the first agent “client,” and the second “server.” This example is not meant to be exhaustive, and many more scenarios exist. Prior to this process the adapter has been configured with enough information to establish a dock to the ZPR network and the client and server have been authenticated.

The sequence for a visa being granted or denied is as follows:
1. A user starts to run an application on their computer.
2. The application acting as the client tries to send a packet to a service (server) using standard OS calls.
3. Based on the address, the operating system routes the connection request to the ZPR adapter.
4. The adapter sends the packet through to the appropriate dock.
5. The dock masks the IP fields in the header and checks for a matching visa.
6. If there is a valid visa, the packet is forwarded.
7. If not, a visa request is sent to the visa service along with the packet header.
8. The visa service finds the subset of communication policies in ZPL whose scope matches the packet header's IP fields (applicable policies).
9. If there are no applicable policies, the visa request is refused.
10. External data sources are queried, in parallel, for the data referenced by the conditions of applicable policies.
11. If all conditions of any policy in applicable policies are met, a visa is issued. If more than one policy's conditions are met, the visa's allowances and duration is a computed combination of these policies.
12. If there are no policies in the applicable policies where all the conditions are met, the visa is refused.

The allowances for a visa are a fixed size array based on network configuration. If the applicable policies require more allowances than the number of allowances specified in a visa, the allowances are combined as follows:
If multiple Quality of Service (QOS) values are the same, a single record for the table is created with that QoS at the highest of the bit-limits/unit-time.
The array is sorted by best QoS first.
If the array exceeds the fixed size, the extra allowances before the last allowance are removed. The forwarder uses this array to check bandwidth limits and to assign QoS:
   When a bit-limit/unit-time is exceeded the next allowance in the array is used.
   If the usage exceeds the allowances in the table, the packet is dropped.

The expiration for a visa is calculated as the most restrictive of authentication durations used by policy conditions and durations explicitly defined by policies. Every attribute that is returned by a data source can have an associated meta-value indicating the duration of its validity. This can be thought of as the amount of time it can be cached, or the amount of time that it can be trusted. The expiration for the visa is set using the shortest duration of all these attributes, and any explicit durations placed on the applicable policies.

When a visa is issued, the following happens:
For bidirectional flow, two visas are created.
The visas, list of matching policies, and any attributes used for issuing get cached.
Visa servers that did not participate in issuance are informed and sent a copy of the visa(s), list of matching policies, and attributes.
The visa and visa egress data are sent to the egress node.
The visa and visa ingress data are sent to the ingress node. The following happens when a visa request is refused:
   Based on logging policy the refusal is logged and added to statistics.
   The refusal is sent to the requester.
   The trust service, based on policy, can decide that the number of refused visa requests have exceeded warning or danger levels and inform administrators through a monitoring system and/or suspend the dock's authentication for a given period of time.

### Authentication Services

Authentication services provide a way for policies to determine if an agent or a node can prove their identity. Identity is tested by asking an agent for information that they have, or have access to, and then checking their response against a desired answer. An agent can have multiple forms of and methods of authentication.

Authentication services support two network APIs. The first, the “challenge request” sends the service the type of Auth and some agent identifying information (such as user ID) and receives back some challenge/encryption information. The second API, the “proof request”, sends data needed to prove that they know a secret or have been granted authentication from a third party and receives back true/false and a duration/expiration time.

A simple example of password authentication:
1. An agent selects an authentication method through a command-line interface or a Graphical User Interface (GUI). In this case they have selected Password Auth, and a user ID and password have been entered.
2. A challenge request is made to the visa service passing the user ID and the Auth Type: Password Auth.
3. The visa service communicates with the Password Auth service and receives data to forward to the agent. In this case the data consists of an Auth GUID and a random string of bytes.
4. The adapter encrypts the password and then creates a cryptographic hash of the encrypted password with the random string of bytes.
5. The Auth GUID and cryptographic hash (the proof request) are sent to the visa service.
6. The visa service forwards this information to the Password Auth service.
7. The authentication service checks the user ID with its own calculated cryptographic hash and certifies or declines authentication to the visa service. This includes a duration for the Auth.
8. The visa service sets the specified attribute for the dock.

The pattern of encrypting, hashing with randomly supplied bytes, and sending only the hash value over secure channels, should be used to prevent any eavesdropping of secrets, and stop replay attacks.

Here are two different examples using OpenID/OAuth (with Google). In the first example the adapter does most of the work:
1. Agent selects Google Auth.
2. Adapter sends a challenge request with a user or class identifier and indicating the Google Auth scheme to the visa service.
3. The visa service contacts the Google Auth Service to get a challenge message (includes the OAuth details, nonce, etc.).
4. Visa service forwards the challenge message to the adapter/agent.
5. Adapter/agent connects to Google OAuth endpoint and performs authentication.
6. Adapter receives the OAuth result from Google.
7. Adapter sends the proof request message to the visa service including the OAuth result from Google.
8. The visa service forwards the proof request message to the Google Auth Service.
9. The Google Auth Service validates the Google authentication material and returns authentication details to the visa service.
10. The visa service updates state and sends a yes/no response to the adapter/agent.

Example where the Auth service shares some of the work:
1. Agent selects Google Auth.
2. Adapter sends a challenge request with a user or class identifier and indicating the Google Auth scheme.
3. The visa service contacts the Google Auth Service to get the OAuth details, nonce, etc.
4. The visa service forwards this data to the adapter/agent.
5. The adapter/agent connects to Google OAuth endpoint and performs authentication.
6. The Google Auth Service receives the OAuth result directly from Google. The post data must match an outstanding OAuth challenge. The user sees feedback in their browser from the Google Auth Service about success or failure.
7. Adapter sends a proof request message to the visa service.
8. The visa service forwards the proof request message to the Google Auth Service.
9. The Google Auth Service checks its cache/waits a small amount of time to see if it has a valid token from Google. Returns result to the visa service.
10. The visa service updates state and sends a yes/no response to the adapter/agent.

### Connection Policies

There are two types of connection policies:
Linking policies control the links between ZPR nodes/forwarders; and
Docking policies control the communication between adapters and docks.

They both issue visa-like tickets to nodes/forwarders.

### Linking Policies

ZPR needs to ensure that forwarding nodes are authorized to connect to the network and to communicate with one another. Linking policies define how these nodes are authenticated and any constraints on their ability to communicate with other nodes.

### Docking Policies

Agents talk to ZPR network docks through adapters. Docking policies (a type of connection policy) ensure that the adapter, and optionally the agent(s), can connect to the dock. Docking policies are similar to communication policies, but they control traffic between the adapter and the dock. Docking policies should be viewed as a low hurdle to connecting to a ZPR network. Communication policies are a second, more restrictive hurdle that keep the network, visa services, etc. from unallowed traffic (Denial-of-Service).

### Communication Policies

Communication policies are used to enable access to services/servers on ZPR. Policies are written from the perspective of a service (a listener), not an agent (a client). They can allow communication based on numerous conditions including-user, group membership, from where and how connected, time of day, and what authentication is required, etc. Communication policies only allow traffic because ZPR denies all traffic by default. By only supporting allowed policies the confusion created by conflicting allow and deny policies and policy priorities are removed. Plain and simple—a communication policy only permits traffic, if there is no policy then there is no traffic, and there cannot be any other policies that prevent this traffic.

### Metadata

It is useful to track information for managing the lifecycle and access communication policies. This is distinct from the fields needed to implement the policies and issue visas. Each communication policy has a unique ID and a name. Policy metadata also includes which system/application/service it is for, who created/owns/modified it and when, and any other descriptive information like comments.

### Scope

Scope defines which packets a communication policy applies to. A policy's conditions are only evaluated after a packet matches a scope. Scopes operate on fields from a packet's header. This includes IP fields and protocol fields. IP fields are fixed, while each protocol defines its own set of protocol fields.

When matching a packet to a scope, each field is checked against the scope's field values. Each of the fields can consist of one or more values or ranges of values. For example, a scope can refer to 3 address ranges and a single address. The same applies to ports, and other fields.

Every field in a scope must match for the scope to apply. All of the policy's conditions must still be met before a visa can be issued.

### Conditions

A list of predicates (statements that evaluate true/false) used to decide if a visa should be issued. The predicates have access to different fields in the packet (based upon protocol), authentication and identity information of the agents involved, ZPR data sources, and external data sources. A limited number of data types and operators are supported (all detailed below). All the conditions (an “and” operation) of a communication policy must evaluate to true for a visa to be issued.

### Request and Response Allowances

Allowances specify a bit-limit/time-unit and a QoS. Requests and responses have different bandwidth constraints and QoS levels which are enforced by forwarding nodes.

Additionally, total bandwidth (amount of data that can be transferred during the visa's duration) can be specified as bytes and/or packets.

### Duration

A time limit and/or a specific time that the visa expires. Visas use actual time, so time limit is converted into actual time by visa services.

### Data

Any type of data can carry a meta-value indicating its duration (probably should be expiration).
Data Types
   Number
   String
   DateTime
   Set

### Internal Data Sources (ZPR Data)

ZPR data consists of information provided by ZPR network components. This includes (but are not limited to):
1. Authenticated user information:
   a. User identification
   b. Forms and times of authentication
   c. Any other useful information from the authentication process
2. Adapter information (potentially spoof-able):
   a. Location
   b. Device information
   c. Forms and times of authentication
   d. Any other useful information
3. Node information:
   a. Node identifier
   b. Location
   c. Capabilities
4. Time
5. ZPR Trust Service

### External Data Sources

External sources of data (external data sources)—information provided by non-ZPR components. Examples include (but are not limited to):
1. User group membership systems (LDAP, Active Directory, etc.).
2. Fine-grain entitlement systems.
3. Business logic systems (hours of operation, etc.).

External data sources are on the visa granting critical path and thus require rapid responses. Visa servers, based on configuration, provide means of caching, and cache invalidation for data sources.

Visa servers connect indirectly to external data sources through Representational State Transfer (REST) APIs, which in turn, connect to the actual sources of data. External data sources perform the translation between any and all sources of data and the visa servers. Visa servers require configuration to connect to external data sources. This configuration could be found through discovery mechanisms, provided by ZAP, or be embedded in the ZPL distribution.

### Data APIs

The use of configurable, ZPR networked APIs, provide many benefits:
1. Visa servers become extensible without need of code modification.
2. New sources of data can be easily added, not just the standard sources of data currently used to manage access (e.g. LDAP, Active Directory).
3. Networked APIs already have standard mechanisms for redundant services.
4. All data required for matching a policy can be fetched in parallel and the requests can be time limited.
5. Requests and responses can be easily cached (and flushed).

### Identity by Continuity

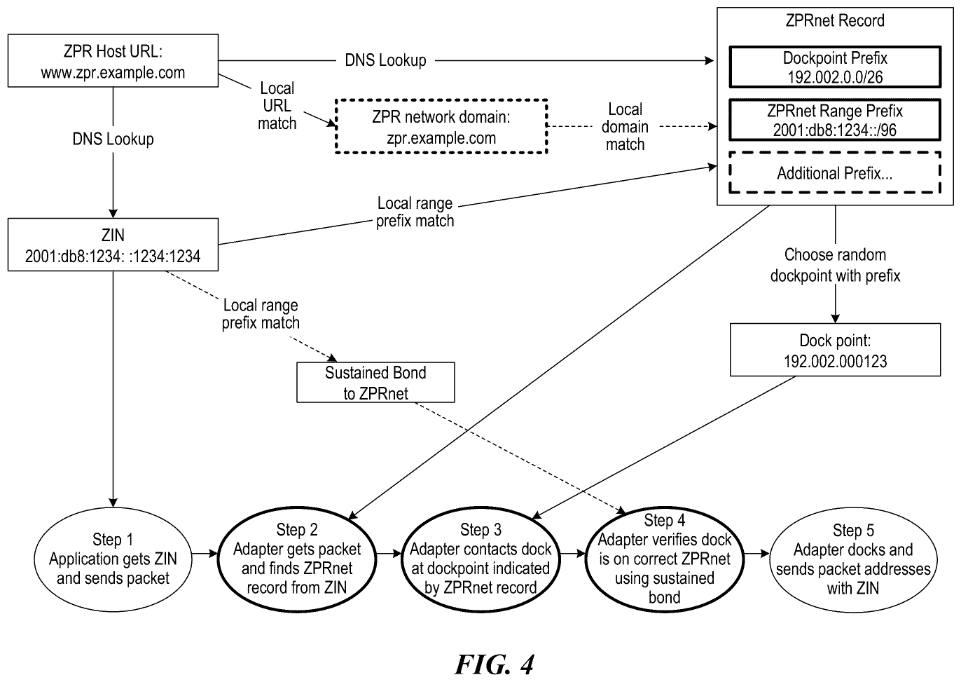

FIG. 4 illustrates a sequence of operations used to create a docking session from a ZIN, with a sustained bond to the ZPRnet according to an embodiment of the invention. The light dashed lines indicate optional use of the DNS to lookup URLs, and the bold dotted lines indicate the use of the sustained bond.

In FIG. 4, an application gets a ZIN and sends a packet (Step 1). The adapter gets the packets and finds a ZPRnet record from the ZIN (Step 2). The adapter contacts the dock at the dockpoint indicated by the ZPR net record (Step 3). The adapter verifies that the dock in o the correct ZPRnet using a sustained bond (Step 4). Finally, the adapter docks and sends the packet addresses with the Zin (Step 5).

### Protocol Stack

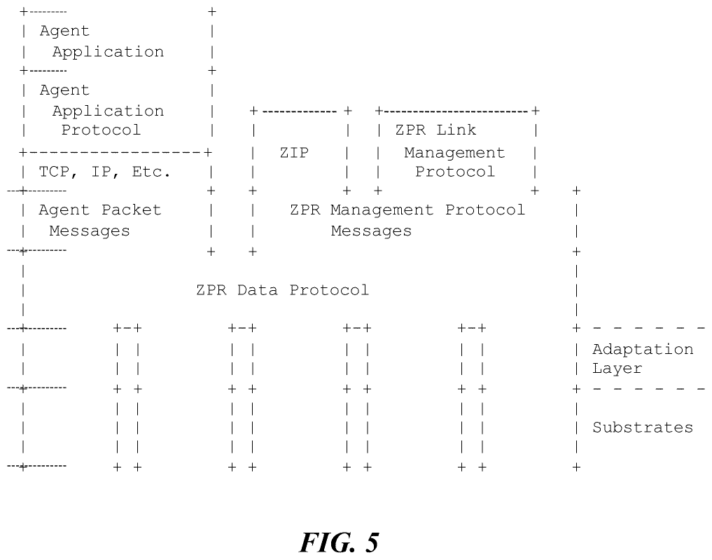

FIG. 5 shows the abstract ZPR-2020 protocol stack, showing the relationships between the various elements according to an embodiment of the invention.

In FIG. 5 the following is noted:

Agent Application: Is the application software that is the source or sink of Agent data. When combined with other identity attributes it is a ZPR Agent. Examples might be web browsers and servers, email clients and servers, and so on. Agent Applications may have a client/server or peer-to-peer relationship; ZPR does not distinguish.

Agent Application Protocol: Is the protocol that the Agent Application uses to communicate over its network connection. Examples include HTTP or SMTP.

TCP, IP, etc.: The lower layer protocols over which the Agent Application Protocol operates.

Agent Packets: The Agent Application Protocol and “TCP, IP, etc.” together comprise Agent Packets. Agent Packets are generated by the Agent Application and are transported by ZPR Transit Packet Messages.

ZIP: Is the ZPR Interface Protocol. This is the administrative protocol between the Dock and Adapter controlling the operations of the Adapter. ZIP is built on top of the Management Protocol Messages.

ZPR Data Protocol (ZDP): This protocol operates between linked ZPR Nodes, as well as between Adapters and Dock. It provides security and demultiplexing services.

ZPR Link Management Protocol: This is the management protocol operating over Links between ZPR Forwarders. It is constructed out of ZPR Management Protocol Messages.

Adaptation Layer: This layer provides whatever functions are needed for ZDP to operate over a given substrate technology. For example, if the substrate is a point-to-point fiber-optic link then the adaptation layer may be something such as IETF Standard PPP[6] in order to provide needed demultiplexing and link state synchronization. In many cases the Adaptation Layer is minimal, or even NULL.

Substrate: The Substrate is whatever it is that ZDP runs over. For ZPR-2020 this is an IP network of some form or a packet-oriented data link of some type.

### Substrate

The Substrate is the network or communications technologies over-top of which the ZPR Network is built. The Substrate must provide a minimal set of well-defined services which ZPR builds upon.

In ZPR-2020 the Substrate can be an IP network or raw datalinks, such as point-to-point fibers or Ethernets, or some combination of these.

### Expected Characteristics

The following are the requirements, non-requirements, and services that ZDP expects of a Substrate:
1. The Substrate provides connectivity between Forwarders and between Docks and Adapters. This connectivity may be:
   a. Point to Point, in which case, the interface out of which a packet is sent determines the destination.
   b. Multipoint, in which case, a packet sent out on an interface could reach a number of destinations. In this case, nodes on the substrate must be assigned Substrate Addresses and the packet includes that address.
2. The Substrate must provide a packet service. The interface to the Substrate accepts packets from the Adaptation Layer for transmission on the Substrate. The Substrate presents packets to the Adaptation Layer that it has received.
3. The Substrate must provide a datagram service, which may be unreliable. When a packet is sent to a peer, it may or may not reach the peer. The Substrate need not provide an indication of delivery status.
4. The Substrate buffers packets only to the degree needed to handle the case of multiple packets attempting to be transmitted out a single interface at the same time. This may happen at the source or at any intermediate nodes within a Substrate network. Packets may be dropped from transmit queues if they are not transmitted in a reasonable, but known (to ZDP), time. They may be dropped if the queue is full. The Substrate need not provide an indication of a drop.
5. The Substrate may be point-to-point, or it may be a network, or internetwork, of some form (that is, divided up into individual segments, with multiple paths, connected by some form of interconnect devices at the Substrate level).
6. The Substrate does not guarantee that packets are received in the order they are transmitted.
7. The interface to a Substrate network should prevent transmission of packets on the Substrate if the substrate network is busy or the transmit queue is full. If this occurs, it should signal that fact to the upper layers. Otherwise, the Substrate should not provide flow or congestion control. If flow or congestion control within the Substrate occurs then packets may be silently dropped.
8. The Substrate does not need to provide fragmentation services. If it does provide them, they should operate transparently to ZDP.
9. The Substrate does not provide security functions.
10. A Substrate may have addresses (Substrate Addresses). It must have them if a packet transmitted on a Substrate interface could go to more than one destination (for example, if the Substrate is an IP network). The architecture, syntax, and semantics of Substrate Addresses are not controlled by ZPR. The Adaptation Layer maintains mappings of ZPR Node Addresses to Substrate Addresses.
11. A ZPR network may operate over-top of a combination of many different Substrate networks. ZPR does not require that these Substrate networks be interconnected other than via ZPR. ZPR does not require that formal interworking standards, protocols, and interfaces be defined by other standards bodies.
12. Substrates are not required to have any network services other than “best efforts, datagram, order-not-guaranteed” delivery. If there are additional services, ZPR may make use of them. Use of any such service for some traffic must not force other traffic to use the service.

### Addressing, Visa ID and Tether ID Overviews

The following discussion provides an overview of how ZPR Addresses and IDs are assigned in a ZPR network.

### Addressing

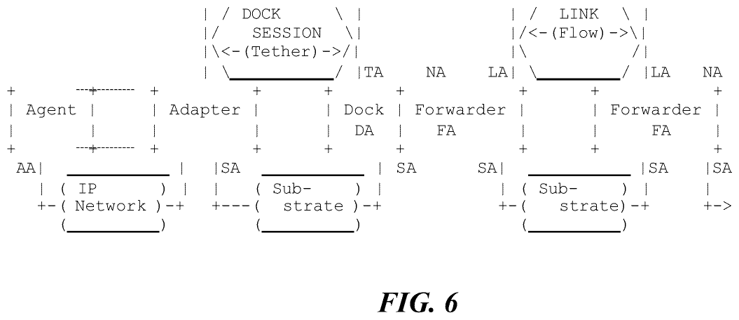

FIG. 6 shows a notional ZPR network. The items on the bottom of the diagram represent the various physical networks over which ZPR builds the ZPR network. The items at the top are the abstract ZPR objects according to an embodiment of the invention, where:

AA, Agent Address: Is the IP address of the Agent. The AA is assigned out of the addresses allocated to the IP Address space of the IP Network on which the Agent resides. These addresses are the source and destination addresses in the Agent Packets. That is, a source Agent addresses a packet to the destination Agent's Agent Address. Agent Addresses are visible, may appear, and are reachable from outside of the ZPR Network.

SA, Substrate Address: Is the ZPR Address of an Adapter's, Dock's, or Forwarder's interface on the Substrate network to which the interface is attached. If the Substrate is an IP network, this is an IP address. If the substrate is a raw Ethernet, the SA is an Ethernet (IEEE802) address. If the substrate is point-to-point (that is, does not have addresses) then the interface would not have a Substrate Address. Substrate Addresses are visible, may appear and are reachable from outside of the ZPR Network.

NA, Node Address: Is the ZPR Address assigned to a Node (either Forwarding or Docking). This address A) uniquely identifies the Node in the ZPR Network, B) may be assigned based on the topology of the ZPR Network, and C) serves as the base for Dock and Forwarder addresses assigned to Docks and Forwarders resident on the Node. The NA is, to use IP terminology, a prefix; out of which Dock and Forwarder Addresses are assigned. For example, if a Node's NA is 1.2.0.0/165 then a Dock on the Node might have DA 1.2.3.0/24 and a Tether connected to the Dock could have TA 1.2.3.4/32. Node Addresses do not appear outside of the ZPR Network.

DA, Dock Address: The ZPR Address is assigned to a Dock within a Node. The DA is derived from the containing Node's NA. The DA uniquely identifies the Dock in the ZPR Network and serves as the basis for assigning Tether Addresses to Tethers terminating on the Dock. Dock Addresses do not appear outside of the ZPR Network.

FA, Forwarder Address: Is a ZPR Address assigned to a Forwarder within a Node. The FA is derived from the containing Node's NA. The FA uniquely identifies the Forwarder in the ZPR Network and serves as the basis for assigning Link Addresses to Links terminating at the Forwarder. Forwarder Addresses do not appear outside of the ZPR Network.

LA, Link Address: Is a ZPR Address assigned to a Link that terminates on a Forwarder. The LA is derived from the Forwarder's FA. A Link has two LAs, one assigned by each Forwarder where the Link terminates.

Link Addresses do not appear outside of the ZPR Network.

TA, Tether Address: Is a ZPR Address assigned to a Tether terminating at a Dock. The TA is derived from the Dock's DA. It uniquely identifies the Tether within the ZPR Network. A Tether connects to a single Adapter and serves, via that Adapter, a single Agent. A key function of the ZPR network is to maintain mappings of an Agent Address to the Tether Address(es) of the Tether(s) serving the Agent. The ZPR Network uses this mapping to calculate a path through the ZPR Network for an Agent Packet, based on the Agent Packet's destination address (which is an Agent Address). Tether Addresses do not appear outside of the ZPR Network.

The NA, DA, FA, TA, and LA do not appear in performance- or space-sensitive areas of the protocols (that is, unlike IP, these addresses do not appear packet headers and are not used by routers, or the like, in forwarding packets).

### Node Model

The following discussion describes various procedures that Docks, Forwarders, and Nodes follow. These procedures are specified with respect to a notional Node, which contains a Forwarder, zero or more externally-facing (that is, connecting to external Adapters) Docks and one or more Substrate network interfaces over which Links and Docking Sessions are to be instantiated. In addition, the Node contains elements of the services which comprise the ZPR Network, such as the Admin Service, Visa Service, and Authentication Service. These elements are ZPR Agents and communicate with their counterparts on other Nodes and back-end servers via their own protocols, operating over ZDP.

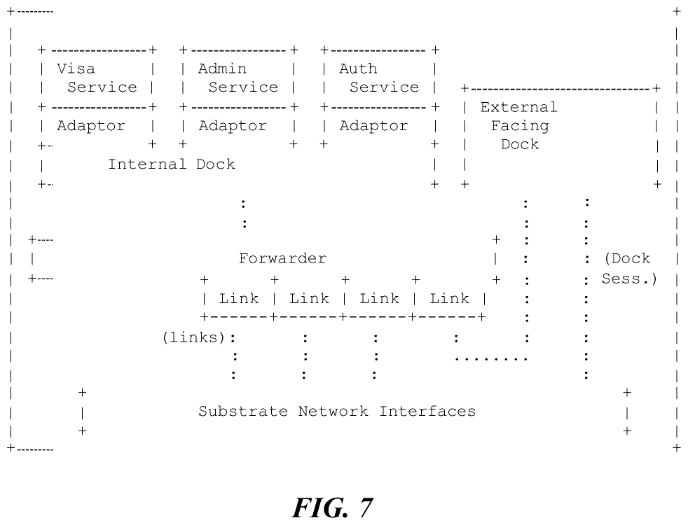

FIG. 7 shows Notional Node Structure according to an embodiment of the invention. The path between the External Facing Dock and a Link to the Forwarder does not (necessarily) flow via a substrate network (it may be an internal subroutine call or message passing interface). However, it is useful to think of it as flowing via a substrate network when discussing the general operations of the Node.

To simplify the descriptions in the following sections, Docks and Forwarders are presumed to contain the following tables:
Dock Forwarding Table (DFT): The Dock contains several DFTs. Each Docking Session and Dock/Forwarder Link has its own DFT. The lookup key is the Tether ID (for Docking Session tables) or Visa ID (for Forwarder Link tables). The result is a Policy Enforcement Procedure (PEP), that specifies how the packet is to be handled—which Docking Session and Tether ID or Forwarder Link and Visa ID that the packet is to be sent out on and so on.
Forwarding Table (FT): The Forwarding Table (similar to the FIB—Forwarding Information Base—in classic IP routers) is used by ZPR Forwarders to determine how a ZDP Transit Packet should be handled.

Each ZPR Configuration that is operational in a ZPR Network MAY have its own Forwarding Table. Conversely, multiple operational configurations may all use a shared FT. Regardless, each Configuration must have a FT, whether shared or private.

The FT takes, as input, the Stream ID from a received ZDP Transit Packet and an identifier of the Link on which the packet was received. It produces a Policy Enforcement Procedure (PEP) describing how the packet is to be handled. The PEP includes the following information:
Link out which the packet should be forwarded. This Link may be an internal Link to a Dock on the Node.
Stream ID to insert in the packet when it is transmitted.
Traffic constraints (such as maximum number of bytes or packets that may be transmitted in a given time period, maximum transmit rates, and so on).
QoS considerations when transmitting the packet, such as pacing or scheduling the traffic, Substrate network QoS marking (such as DSCP on IP Substrates), transmit queue assignment, and so on.

In addition, the PEP may also indicate other dispositions of the packet such as:
Silently discarding the packet.
Discarding the packet and sending a specified “Destination Unreachable” Management Message.

It might seem reasonable to specify that if a lookup in the FT fails, a PEP specifying that a “Destination Unreachable” message of some form always be sent upstream. We do not do this because sending a “Destination Unreachable” might reveal sensitive information to an attacker. Thus, we allow ZPR Policy to determine the action taken when a lookup fails (of course, the policy may direct that a Destination Unreachable be sent).

There are internal APIs between the various service Agents, the Docks, Links, and the Forwarder. These APIs are used to pass management, control, and reporting information among the various entities. These APIs are implementation specific and not specified. For example, if a Link detects a failure, it informs the Admin Service of this via an internal API.

The Node described above is notional and serves as context in which ZPR operations may be specified. It is not meant to be prescriptive nor an actual implementation design. Implementors may design their Nodes in any way, so long as the functions and processes described below perform as described.

Adapters contain two lookup tables. Packets received from the Agent are looked up in the first, the Agent Lookup Table. This table is keyed by the IP Address, protocol, and port numbers of the packet and produces a PEP that specifies how the packet is to be compressed and what Stream ID to use when sending the packet to the Dock. The second table, the Dock Lookup Table, reverses the operation; the Stream ID from received Transit Packets is looked up in the table, producing a PEP specifying the Agent IP addresses, protocol, and port numbers as well as decompression instructions.

### General Setup Operations

In general, the sequence of operations is:
1) Forwarders establish links between each other as directed by Connection Policies.
2) An Adapter establishes a Docking Session with a Dock. As a part of this, the Adapter registers the Substrate Addresses (typically IP addresses) with the Dock via the Register Agent Address message. The Dock passes the Agent Address(es) as well as the Dock's ZPR Address to the Topology Service.
3) A source Agent sends the first Agent Packet to some destination Agent. The destination address in this packet is the Agent Address of the destination Agent (the source address is the Agent Address of the source Agent). This packet is actually received by the ingress Adapter.
4) The Ingress Adapter requests a Stream ID for the Agent IP Addresses, IP protocol and UDP or TCP ports (if the packet is UDP or TCP) tuple from the Dock. The Bind Agent Address message is used for this.
5) The Dock:
   a. Checks its tables to see if the packet is covered by an existing Visa. If so, the Dock responds to the Bind Agent Address request with an appropriate Stream ID.
   b. If there is no satisfactory Visa, the Dock requests a Visa from the Visa Service. The Visa Service performs whatever operations are necessary to evaluate the request and grant a Visa. In particular, the Visa Service may do a ZPR Authentication of the Agent using the Authentication Messages.
   c. The Visa Service issues a Visa to the Ingress Dock. The Visa Service may also install the Visa on the intermediate Forwarders and Egress Dock. The Visa Service uses the Topology Service to determine the path through the network that the packets should take. It knows the Dock to which the destination is connected because the destination has registered its Agent Address when it connected to the ZPR Net (see step 2 above).
   d. The Dock responds to the Bind Agent Address request with an appropriate Stream ID.
6) The Adapter builds appropriate tables to forward Agent Packets of the Flow via the Stream ID it received from the Dock.
7) As the first Agent Packet of the Flow traverses the network, the Visa is heralded. If the Visa is installed only in the Ingress Dock, the entire Visa is included in the herald messages. If the Visa is installed in each Forwarder and the Egress Dock, only the Visa's name is in the herald messages. When a Forwarder or the Egress Dock receives a Visa Herald Request, it responds with e Stream ID to use when forwarding packets of the Flow permitted by the Visa.
8) The Agent packets are forwarded through the network:
   a. The Ingress Adapter compresses the Agent Packets, removing fields from the Agent Packet as directed by the Dock in the Bind Agent Address response.
   b. The Ingress Adapter generates the D2D MICV for the Agent Packet. The SA parameters (keys, algorithms, and other parameters) are received from the Visa Service and sent to the Adapter in the Bind Agent Address response. The keys are encrypted by the Visa Service using a key known only by the adapter, e.g. it may be generated as a result of the Authentication operation or by the Adapter's public key.
9) When the packet reaches the Egress Adapter it checks the MICV, decompresses the Agent Packet and then sends the packet to the Agent.

### Link and Docking Session Finite State Machines

ZPR Links and Docking Sessions operate using simple finite state machines (FSMs). The FSMs for each are only slightly different and the description of them is as common as possible (in order to avoid repeatedly defining the same events, states, or transitions with the possibility that the definitions, which are intended to be the same, in fact diverge).

If the Agent sends IPV6 packets or IPv4 packets with the DF (Don't Fragment) bit set then the Agent's Adapter will intercept the packets, evaluate them against the PMTU for the Tether that the packets would traverse, and, if the packets are too big, drop the packets and send an appropriate ICMP message back the Agent. This is the normal and expected IP behavior.

This does not cover the case of the Agent sending IPV4 packets with the DF bit clear. In this case, the Agent would expect that the packets will be fragmented if needed. Sending an ICMP message back to the Agent might work, but then again, it might not.

Options for addressing this are:
1) Ignore it. If a ZDP packet reaches some point where it exceeds the MTU, it is silently dropped. This might even be done at the Ingress Adapter. As an implementation strategy, we might adopt this since fragmentable IPv4 packets are probably fairly rare these days. However, as a protocol architecture/design matter, we should have a better solution. This option is rejected.
2) Have the ingress Adapter (or any other point in the network) fragment Agent IPv4 packets with DF=0 if needed. In this option, whenever a ZDP packet is too big to traverse the next hop Link or Docking Session, the IPv4 packet carried in the ZDP Transit Packet is extracted from the ZDP packet, fragmented per the normal IPv4 fragmentation rules, and then sent to the next hop in two or more ZDP packets:

### Computer Implementation

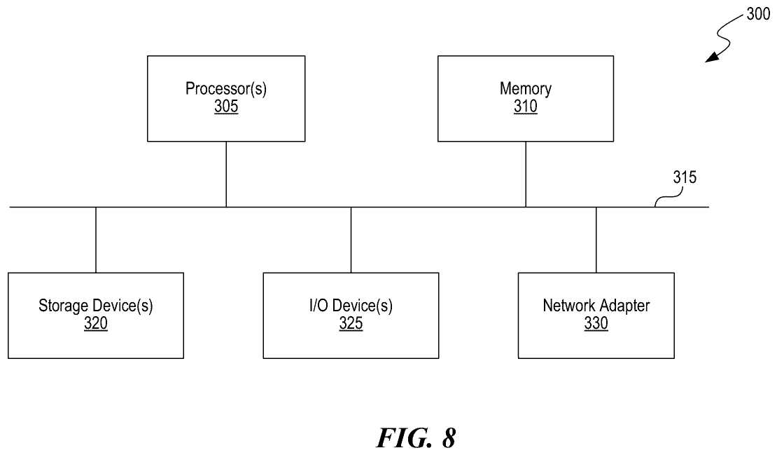

FIG. 8 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 300 may include one or more central processing units (“processors”) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The memory 310 and storage devices 320 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330.

The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/We claim:

1. A method for moving IP-format packets though a network, comprising:
encapsulating IP-format packets into a compressed form by replacing any of addresses, ports, protocols, and other header fields of the IP packet with a visa identifier; and
binding each packet to the identity and permissions of a sender each time a node processes a packet;
wherein a same visa identifier that determines what is done with the packet certifies that the identities of both a sender and receiver have been authenticated;
wherein said same visa identifier certifies that a policy allows the packet to be sent by the sender to the receiver under certain specific conditions;
wherein all said information is derived from said same visa identifier; and
wherein certification is inseparably bound to a destination and to said specific conditions.

2. The method of claim 1, wherein said same identifier specifies a secret key, known only to ingress and egress nodes, that is used to calculate a message integrity check value (MICV) that allows the receiver to know that the packet was generated by an authenticated source and not altered in transit;
wherein the same visa identifier that determines the path also specifies conditions to be checked at each hop; and
wherein delivery of the packet confirms that the packet is compliant with policy.

3. A method for moving IP-format packets though a network, comprising:
encapsulating IP-format packets into a compressed form by replacing any of addresses, ports, protocols, and other header fields of the IP packet with a visa identifier:
tracking a number and size of messages that have been transmitted in each class of traffic; and
reserving bandwidth for a specific use by defining a special class of traffic that has a higher priority than other traffic;
wherein said visa identifier grants permission to send a specific amount of said high-priority by-reservation-only traffic within a specified time interval;
based on said visa identifier, a visa service reserving bandwidth in different classes for specific purposes;
wherein availability of said reserved bandwidth is guaranteed when a total bandwidth that can be reserved is not allowed to be greater than the amount of high-priority traffic that can be carried; and
wherein said traffic classes are allowed to use additional unreserved bandwidth when it is available.

4. The method of claim 3, wherein additional storage and processing within nodes is required to keep track of an amount of bandwidth used by each class of traffic;
wherein said additional storage and processing is not required for all visa identifiers; and
wherein said additional storage and processing is used only when needed.

5. A method for moving IP-format packets though a network, comprising:
encapsulating IP-format packets into a compressed form by replacing any of addresses, ports, protocols, and other header fields of the IP packet with a visa identifier;
tracking a number and size of messages that have been transmitted;
implementing limits on an amount of information that can be transmitted under a particular permission; and
based on said visa identifier, a visa service using reserving bandwidth based on permission;
wherein additional bandwidth is not made available once a reserved bandwidth is exhausted.

6. The method of claim 5, further comprising:
implementing permissions that limit large-scale data exfiltration.

7. In a network consisting of a set of communicating nodes and internal services, including a visa service and an administrative service, a method comprising:
encapsulating IP-format packets into a compressed form by replacing any of addresses, ports, protocols, and other header fields of the IP packet with a visa identifier providing one or more individual instances of said network;
wherein each individual instance of said network comprises its own communication policies; and
wherein every node of said network enforces said policies.

8. The method of claim 7, wherein a single node is configurable to implement any combination of functions of docks, forwarders, and node endpoints, as long said node enforces the policies on all packets that pass through it.

9. The method of claim 7, wherein an entire private cloud, real or virtual, comprises a single node.

10. The method of claim 9, wherein in said private cloud, cloud processors comprise node endpoints;
wherein said network does not specify how said policy is enforced within said single node;
wherein said private cloud uses its own internal interfaces, packet formats, and internal network to enforce policy within said single node.

11. The method of claim 9, wherein docks are implemented by cloud processors or by specialized network interfaces that serve as gateways for any communication outside of the private cloud's internal network.

12. In a network consisting of a set of communicating nodes and internal services, including a visa service and an administrative service, a method comprising:
defining an agent's identity as a collection of authenticated attributes, with values that are uniquely associated with said authenticated attribute within a network in which IP-format packets are encapsulated into a compressed form by replacing any of addresses, ports, protocols, and other header fields of the IP packet with a visa identifier;
wherein said authenticated attribute comprises at least one immutable attribute of that which is being authenticated.

13. The method of claim 12, further comprising:
using an authentication service to authenticate a machine serial number;
assigning a “machine_id” attribute to said machine;
wherein said authentication service must always return said “machine_id” each time said machine is authenticated.

14. The method of claim 12, further comprising:
authenticating an agent by multiple services;
wherein each service produces evidence of authentication; and
wherein each additional authentication by an agent is added to said agent's identity.

15. The method of claim 12, wherein identities have lifetimes; and
wherein the lifetime of an agent's identity is a minimum of all the lifetimes from each of the agent's authentications.

16. The method of claim 12, wherein lifetimes are reduced by policy.

17. The method of claim 12, wherein an agent is re-authenticated when an identity has expired to allow said agent to continue to function.

18. The method of claim 12, wherein identities comprise provenance; and
wherein each component of an agent's identity comprises information about its source including any of a name of a trusted source that produced the agent's identity and a digital signature indicating the agent's authenticity and veracity.

19. The method of claim 12, further comprising:
assigning a globally unique identifier (GUID) to each successful authentication;
wherein said GUID is logged along with the full identity; and
wherein the GUID is used in any further logging messages and in visas and other internal messaging where appropriate.

20. A method for transmitting a packet across a packet-switched communications network consisting of multiple nodes, comprising:
transmitting packets from a first communicator to a first node of the network which is associated with a source address;
transmitting packets from a second node of the network to a second communicator which is associated with a destination address;
each node communicating bidirectionally with a visa service;
the visa service determining communications policies of the network;
the visa service determining when the transmission of a first packet is compliant with the policies of the network;
wherein when a first packet is transmitted to the first node of the network, the first node communicates with the visa server information derived from the first packet to determine if the delivery of the first packet is compliant with the policies of the network; and
wherein the first packet is delivered to the second node only if it is compliant with policies as determined by the visa service.

21. The method of claim 20, further comprising:
the visa service determining attributes of the communicators;
wherein the policies of the network are dependent on the attributes of communicators.

22. The method of claim 21, further comprising:
the first packet providing a communication to prove its identity to a node.

23. The method of claim 21, further comprising:
a communicator demonstrating to a node that it has access to credentials that prove its identity.

24. The method of claim 20, wherein the policies of the network depend on the destination address of the second node; and
wherein the information transmitted by the first node to the visa service includes the destination address associated with the second node.

25. The method of claim 20, wherein the policies of the network depend on the source address of the first node; and
wherein the information transmitted by the first node to the visa service includes the source address associated with the first node.

26. The method of claim 20, further comprising:
the visa service communicating to the first and second node a cryptographic key used for computing a message integrity check value (MICV).

27. The method of claim 20, further comprising:
the visa service providing the first node with a visa ID when the packet is policy compliant;
the visa service communicating the visa ID and associated forwarding information to a set of nodes along a path the connects the first and second node;
the first node creating a second packet that includes the visa ID and transmitting it to the first node on the connecting path; and
the set of nodes along the connecting path forwarding the packet with the visa ID along the path.
